(19) United States
(12) Patent Application Publication
(10) Pub. No.: US 2025/0245491 A1
(43) Pub. Date: Jul. 31, 2025

(54) ELECTRONIC DEVICE FOR GENERATING FILE ASSOCIATED WITH RESTORATION FUNCTION AND METHOD THEREOF

(71) Applicant: Samsung Electronics Co., Ltd., Suwon-si (KR)

(72) Inventors: Nagyeom YOO, Suwon-si (KR); Jihun MUN, Suwon-si (KR); Moonsoo KIM, Suwon-si (KR); Donghyun YEOM, Suwon-si (KR); Sunghyuk SHIN, Suwon-si (KR)

(21) Appl. No.: 18/931,735

(22) Filed: Oct. 30, 2024

Related U.S. Application Data
(63) Continuation of application No. PCT/KR2024/015467, filed on Oct. 14, 2024.

(30) Foreign Application Priority Data
Jan. 26, 2024 (KR) 10-2024-0012733
Mar. 12, 2024 (KR) 10-2024-0034650

(51) Int. Cl. G06N 3/0475

(52) U.S. Cl. CPC G06N 3/0475

(57) ABSTRACT

An electronic device according to an embodiment displays an image including at least one object via a display. The electronic device receives an input for the at least one object. The electronic device generates an artificial intelligence image using an artificial intelligence model wherein the at least one object is replaced with an object generated by an artificial intelligence based at least in part on the input. The electronic device generates first information on the input and second information on an object generated by the artificial intelligence. The electronic device stores metadata including the first information and the second information and a file including the artificial intelligence image in the memory.

### CROSS-REFERENCE TO RELATED APPLICATIONS

This application is a continuation International Application No. PCT/KR2024/015467 designating the United States, filed on Oct. 14, 2024, in the Korean Intellectual Property Receiving Office and claiming priority to Korean Patent Application Nos. 10-2024-0012733, filed on Jan. 26, 2024, and 10-2024-0034650, filed on Mar. 12, 2024, in the Korean Intellectual Property Office, the disclosures of each of which are incorporated by referenced herein in their entireties.

### BACKGROUND

### Field

The present disclosure relates to an electronic device for generating a file associated with restoration and a method thereof.

### Description of Related Art

Technology for processing a photo and/or a video using artificial intelligence is being developed. For example, technology for recognizing one or more characters (or a string) associated with the photo and/or the video is being developed. For example, technology for classifying a subject (e.g., an object including a person, an animal, and/or a vehicle) captured by the photo and/or the video.

The above-described information may be provided as a related art for the purpose of helping to understand the present disclosure. No claim or determination is made as to whether any of the above-described information may be applied as a prior art related to the present disclosure.

### SUMMARY

According to an example embodiment, an electronic device may comprise a display, at least one processor comprising processing circuitry, and memory, comprising one or more storage mediums, storing instructions. At least one processor, individually and/or collectively, may be configured to control the display to display an image including at least one object. At least one processor, individually and/or collectively, may be configured to receive an input with respect to the at least one object. At least one processor, individually and/or collectively, may be configured to, based at least in part on the input, generate an artificial intelligence (AI) image using an AI model wherein the at least one object is replaced with an AI generated object. At least one processor, individually and/or collectively, may be configured to generate first information with respect to the input and second information with respect to the AI generated object. At least one processor, individually and/or collectively, may be configured to store, in the memory, a file including the AI image and metadata including the first information and the second information.

In an example embodiment, a non-transitory computer-readable storage medium comprising instructions may be provided. The instructions, when executed by at least one processor, individually and/or collectively, of an electronic device including a display, may cause the electronic device to display, via the display, an image including at least one object. The instructions, when executed by at least one processor, individually and/or collectively, of an electronic device, may cause the electronic device to receive an input with respect to the at least one object. The instructions, when executed by at least one processor, individually and/or collectively, of an electronic device, may cause the electronic device to, based at least in part on the input, generate an artificial intelligence (AI) image using an AI model wherein the at least one object is replaced with an AI generated object. The instructions, when executed by at least one processor, individually and/or collectively, of an electronic device, may cause the electronic device to generate first information with respect to the input and second information with respect to the AI generated object. The instructions, when executed by at least one processor, individually and/or collectively, of an electronic device, may cause the electronic device to store, in the memory, a file including the AI image and metadata including the first information and the second information.

According to an example embodiment, an electronic device may comprise: a display, at least one processor comprising processing circuitry, and memory, comprising one or more storage mediums, storing instructions. At least one processor individually or collectively, may be configured to execute the instructions and to cause the electronic device to: display, on the display, an edit screen including an original image. At least once processor individually or collectively, may cause the electronic device to, based on receiving a first input to edit the original image, via the edit screen, execute an artificial intelligence model using the first information associated with the first input, and generate an edited image corresponding to the original image. At least one processor individually or collectively, may cause the electronic device to, in response to the first input, display the edited image on the edit screen. At least one processor individually or collectively, may cause the electronic device to, while displaying the edited image, based on receiving a second input to store the edited image, generate second information associated with the artificial intelligence model to be executed to restore the original image. At least one processor individually or collectively, may cause the electronic device to store, in the memory, a file including the edited image and metadata including the first information and the second information.

In an example embodiment, a non-transitory computer-readable storage medium comprising instructions may be provided. The instructions, when executed by at least one processor, comprising processing circuitry, individually and/or collectively, of an electronic device including a display, may cause the electronic device to display, on the display, an edit screen including an original image. The instructions, when executed by at least one processor, comprising processing circuitry, individually and/or collectively, of the electronic device including the display, may cause the electronic device to, based on receiving a first input to edit the original image, via the edit screen, execute an artificial intelligence model using first information associated with the first input, and generate an edited image corresponding to the original image. The instructions, when executed by at least one processor, comprising processing circuitry, individually and/or collectively, of the electronic device including the display, may cause the electronic device to, in response to the first input, display the edited image on the edit screen. The instructions, when executed by at least one processor, comprising processing circuitry, individually and/or collectively, of the electronic device including the display, may cause the electronic device to, while displaying the edited image, based on receiving a second input to store the edited image, generate second information associated with the artificial intelligence model to be executed to restore the original image. The instructions, when executed by at least one processor, comprising processing circuitry, individually and/or collectively, of the electronic device including the display, may cause the electronic device to store, in the memory, a file including the edited image and metadata including the first information and the second information.

In an example embodiment, a method of an electronic device comprising a display may be provided. The method may include displaying, on the display, an edit screen including an original image. The method may include, based on receiving a first input to edit the original image, changing a first portion of the original image. The method may include, while displaying an edited image which is the original image of which the first portion is changed to a second portion, based on receiving a second input to store the edited image, storing a file including first metadata indicating the second portion, second metadata including information to restore content of the first portion of the original image different from the edited image using an artificial intelligence model, and the edited image from among the original image or the edited image.

According to an example embodiment, an electronic device may comprise: a display, at least one processor comprising processing circuitry, and memory, comprising one or more storage mediums, storing instructions. At least one processor individually or collectively, may be configured to execute the instructions and to cause the electronic device to: display, on the display, an edit screen including an original image. At least one processor individually or collectively, may cause the electronic device to, based on receiving a first input to edit the original image, change a first portion of the original image. At least one processor individually or collectively, may cause the electronic device to, while displaying an edited image which is the original image of which the first portion is changed to a second portion, based on receiving a second input to store the edited image, store a file including, first metadata indicating the second portion, second metadata including information to restore content of the first portion of the original image different from the edited image using an artificial intelligence model, and the edited image from among the original image or the edited image.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a diagram illustrating an example operation of an electronic device that generates a file including an edited image for an original image according to various embodiments;

FIGS. 2A and 2B are block diagrams illustrating an example configuration of an electronic device according to various embodiments;

FIG. 3 is a flowchart illustrating an example operation of an electronic device that generates an edited image for an original image according to various embodiments;

FIG. 4 is a diagram illustrating an example structure of a file generated by an electronic device according to various embodiments;

FIG. 5 is a diagram illustrating an example operation of an electronic device for displaying an edit screen on a display according to various embodiments;

FIGS. 6A, 6B, 6C, 6D, 6E, and 6F are diagrams illustrating example structures of an image editing model executed by an electronic device according to various embodiments;

FIG. 7 is a diagram illustrating an example operation of an electronic device that generates a file including pixel information for at least a portion of an original image different from an edited image according to various embodiments;

FIG. 8 is a diagram illustrating an example operation of an electronic device that generates a file using pixel differences between an edited image and an original image according to various embodiments;

FIG. 9 is a diagram illustrating an example operation of an electronic device that generates a file including pixel information and/or data (e.g., a prompt) according to various embodiments;

FIG. 10 is a diagram illustrating an example operation of an electronic device that generates a file including feature information to be used to restore an original image according to various embodiments;

FIG. 11 is a diagram illustrating an example operation of an electronic device that generates a file including one or more prompts to be used to restore an original image according to various embodiments;

FIG. 12 is a diagram illustrating an example operation of an electronic device that generates a file including one or more prompts for at least a portion of an original image different from an edited image according to various embodiments;

FIG. 13 is a diagram illustrating an example operation of an electronic device that generates a file including one or more prompts and location information associated to an original image according to various embodiments;

FIG. 14 is a diagram illustrating an example operation of an electronic device for restoring an original image according to various embodiments;

FIG. 15 is a diagram illustrating example programs executed by an electronic device to simulate a generative artificial intelligence model according to various embodiments; and

FIG. 16 is a block diagram illustrating an example electronic device in a network environment according to various embodiments.

### DETAILED DESCRIPTION

Hereinafter, various example embodiments of the disclosure will be described with reference to the accompanying drawings.

The various example embodiments of the disclosure and terms used herein are not intended to limit the technology described in the disclosure to specific embodiments, and should be understood to include various modifications, equivalents, or substitutes of the corresponding embodiment. In relation to the description of the drawings, a reference numeral may be used for a similar component. A singular expression may include a plural expression unless it is clearly meant differently in the context. In the disclosure, an expression such as “A or B”, “at least one of A and/or B”, “A, B or C”, or “at least one of A, B and/or C”, and the like may include all possible combinations of items listed together. Expressions such as “1st”, “2nd”, “first” or “second”, and the like may modify the corresponding components regardless of order or importance, is simply used to distinguish one component from another component, but does not limit the corresponding components. When a (e.g., first) component is referred to as “connected (functionally or communicatively)” or “accessed” to another (e.g., second) component, the component may be directly connected to the other component or may be connected through another component (e.g., a third component).

The term “module” may include a unit configured with hardware or firmware, and may be used interchangeably with terms such as logic, logic block, component, or circuit, and the like. The module may be an integrally configured component or a minimum unit or part thereof that performs one or more functions. For example, a module may be configured with an application-specific integrated circuit (ASIC).

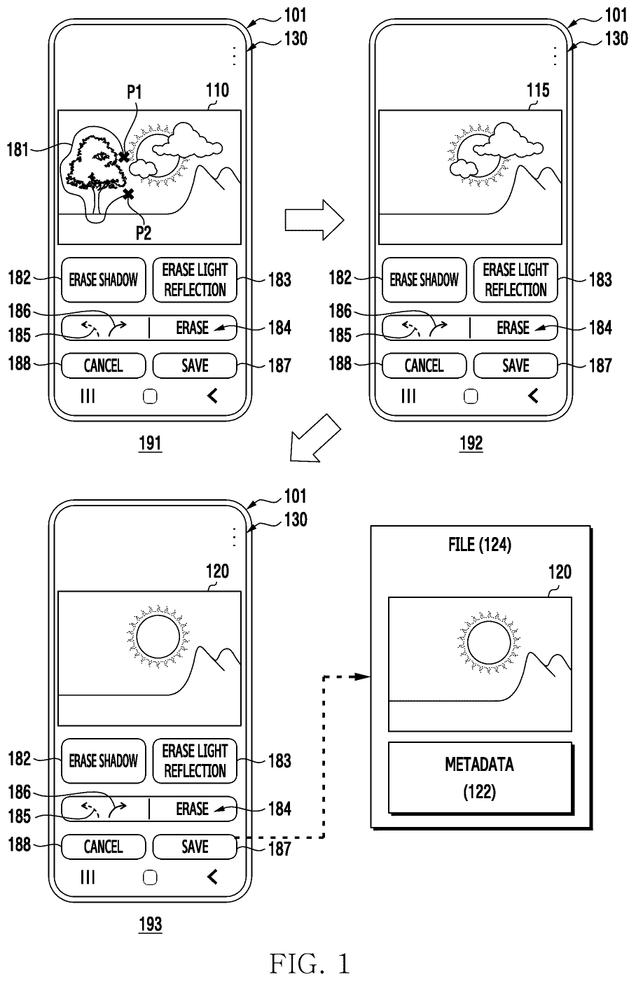

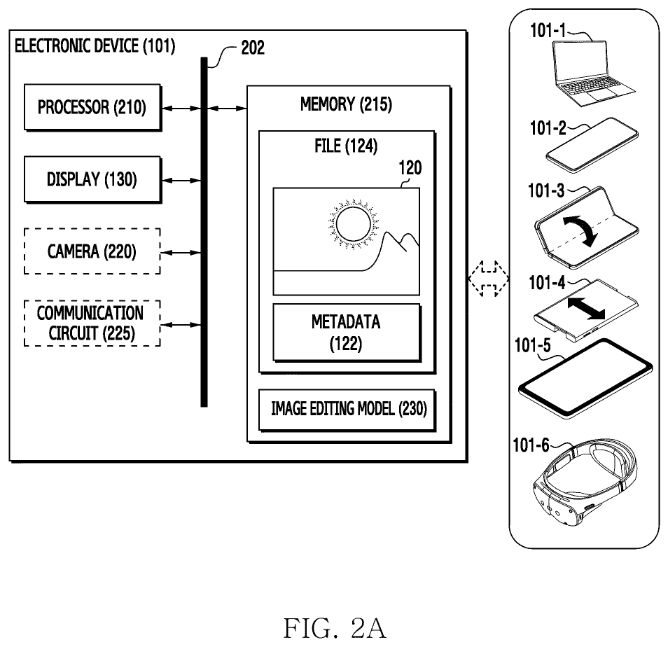

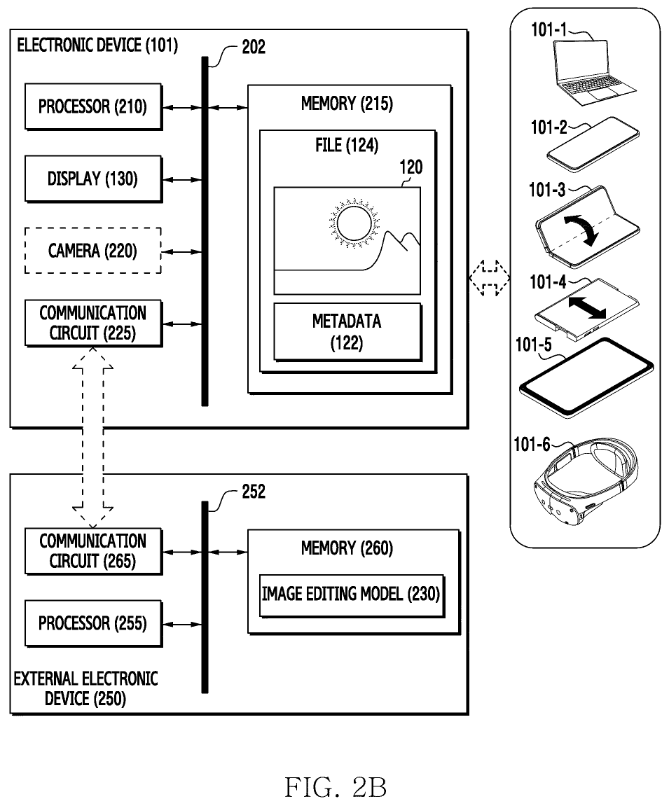

FIG. 1 is a diagram illustrating an example operation of an electronic device 101 that generates a file 124 including an edited image 120 for an original image 110 according to various embodiments. Referring to FIG. 1, the electronic device 101 having a shape of a mobile phone is illustrated. The electronic device 101 may include a display 130 visible on a surface of a housing. Various example form factors of the electronic device 101 including the display 130 will be described with reference to FIGS. 2A and/or 2B.

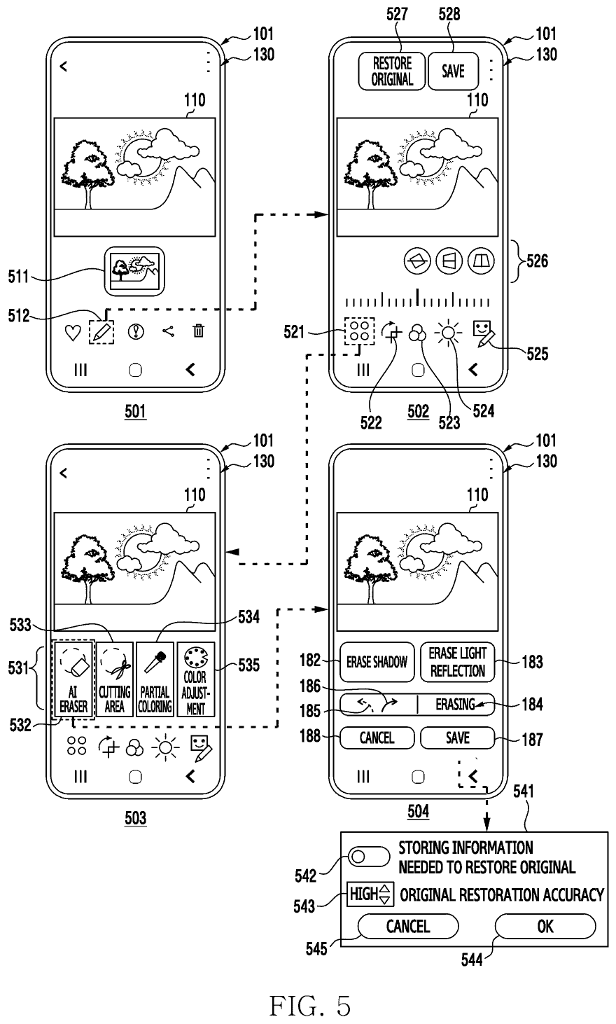

Referring to FIG. 1, example states 191, 192, and 193 of the electronic device 101 displaying an edit screen including the original image 110 are illustrated. The edit screen may be provided by a software application for browsing images and/or videos stored in the electronic device 101, such as a gallery application. The electronic device 101 may display, together with the original image 110, visual objects 182, 183, 184, 185, 186, 187, and 188 associated with editing of the original image 110 on a screen including the original image 110. An example of the edit screen displayed on the display 130 will be described with reference to FIG. 5.

For example, a visual object 182 may be associated with a function that reduces or removes a shadow expressed in the original image 110 (or selected by an input associated with the original image 110). For example, a visual object 183 may be associated with a function that reduces or removes reflected light expressed in the original image 110. For example, a visual object 185 may be associated with a function (e.g., undo) that sequentially reverses edit actions applied to the original image 110 by one or more inputs. For example, a visual object 186 may be associated with a function (e.g., redo) that re-execute a function canceled by the visual object 185. For example, a visual object 184 may be associated with a function that removes a subject from an image 110 by changing at least a portion of the original image 110 expressing the subject. For example, a visual object 187 may be associated with a function that stores a result of editing the original image 110 displayed on a screen in a file 124. For example, a visual object 188 may be associated with a function that ceases or cancels editing the original image 110.

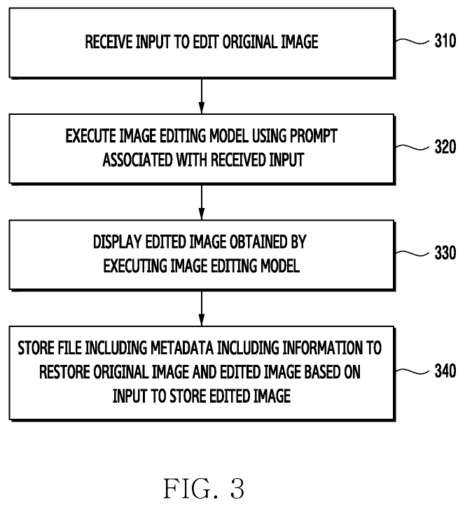

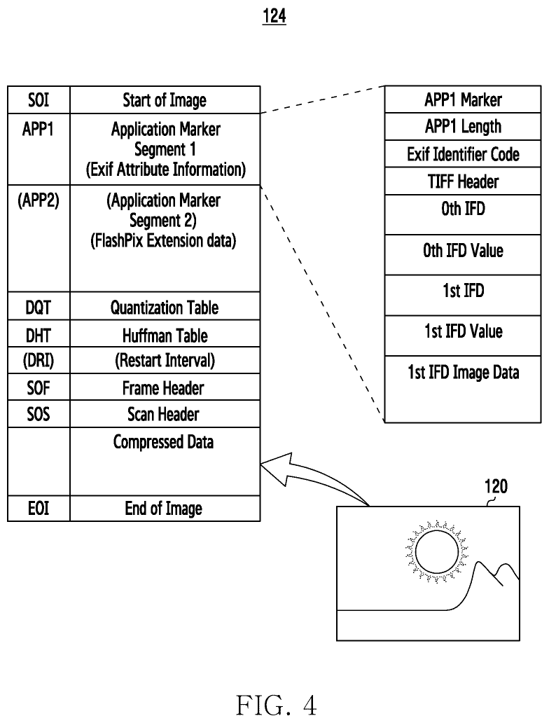

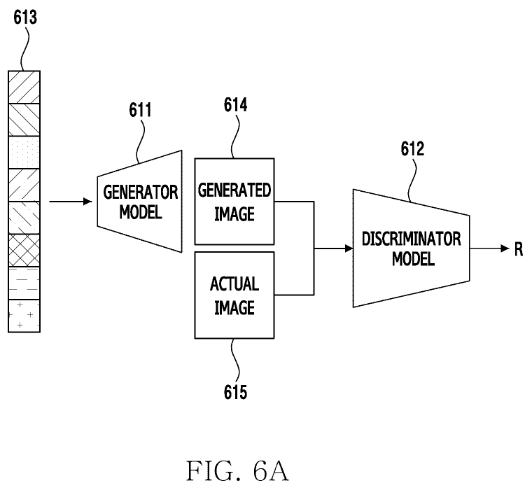

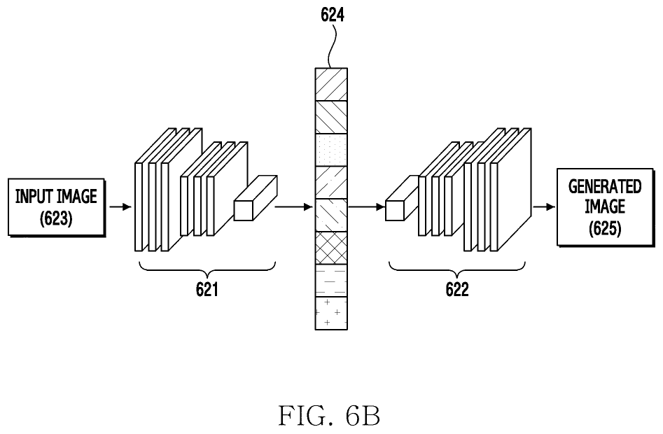

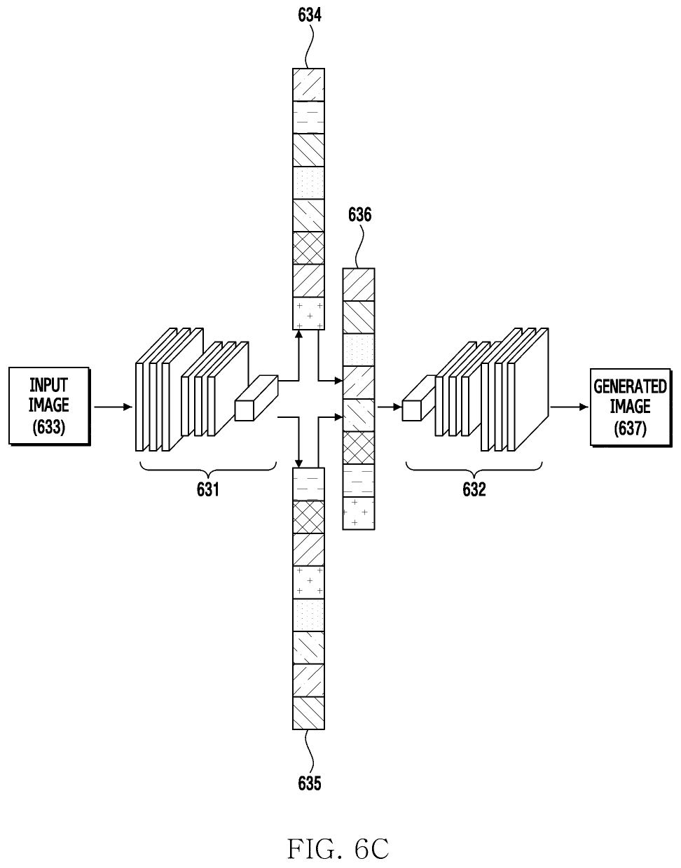

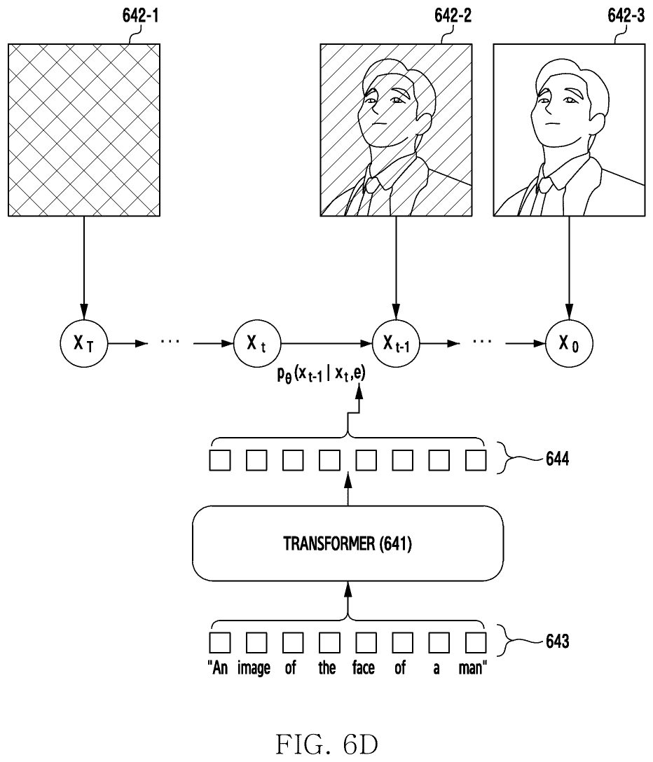

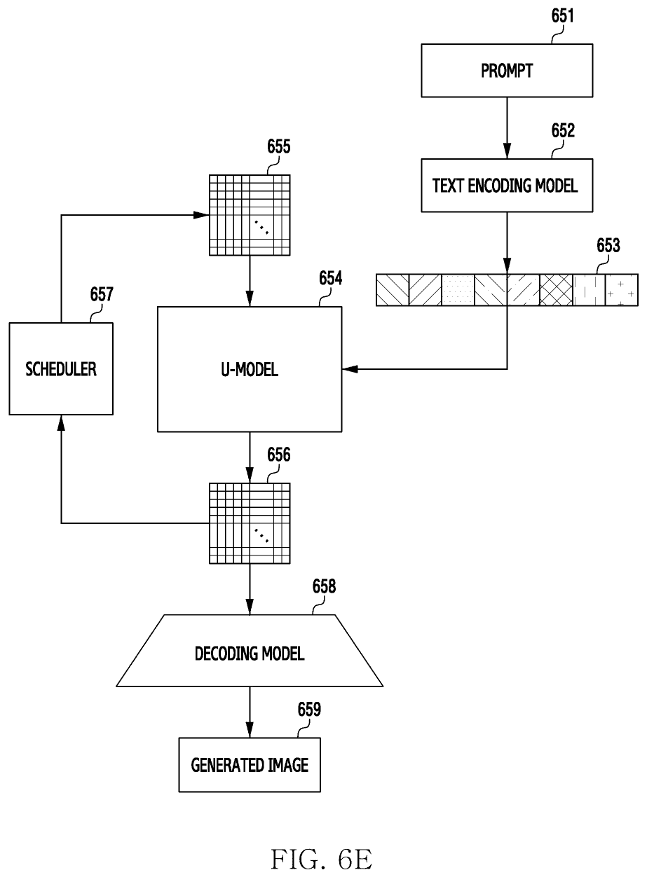

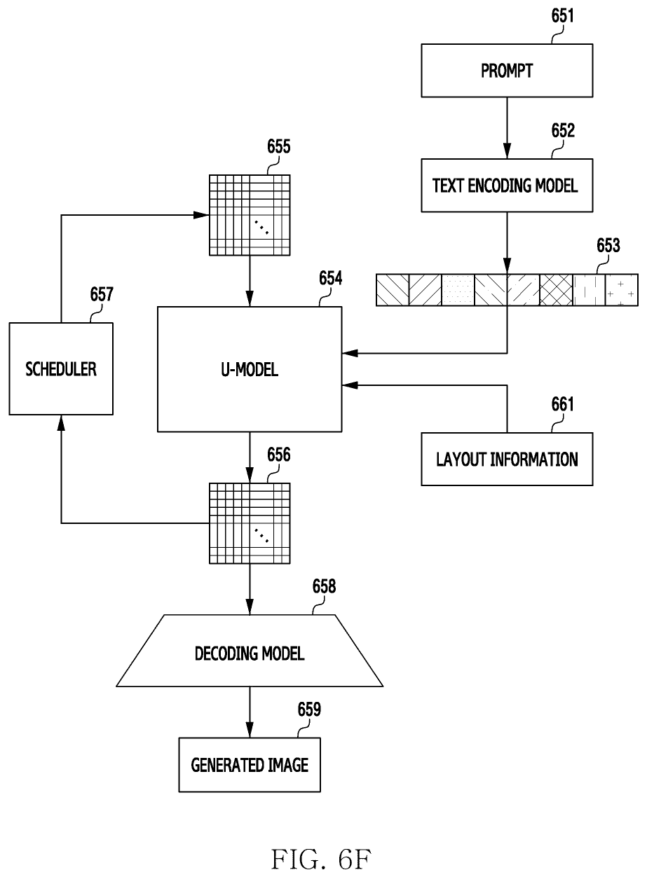

In an embodiment, functions associated with visual objects 182, 183 and 184 may cause execution of an artificial intelligence model. In the present disclosure, artificial intelligence model executed to at least partially change the original image 110 may be referred to as an image editing model. An example operation of the electronic device 101 of changing the original image 110 by executing an image editing model will be described in greater detail below with reference to FIG. 3. According to an embodiment, the electronic device 101 may execute the image editing model to obtain an edited image (e.g., edited images 115 and 120), which is a result obtained by at least partially changing the original image 110. The electronic device 101 may generate or store the file 124 including only the edited image among the original image 110 or the edited image. An example operation of the electronic device 101 for generating the file 124 will be described in greater detail below with reference to FIG. 4. An artificial intelligence model including the image editing model may include a computational model executed by the electronic device 101 to simulate a neural activity (e.g., inference, perception, and/or creation) of a living organism. The artificial intelligence model will be described in greater detail below with reference to FIGS. 6A to 6F.

Within an example state 191 of FIG. 1, the electronic device 101 may receive an input to edit the original image 110. For example, the input to edit the original image 110 may include a first input indicating a selection of a portion associated with an example subject such as a trec. The first input may be detected by an external object dragged from a point p1 along a path 181 to a point p2, on the display 130 on which the original image 110 is displayed. In response to the first input, the electronic device 101 may display a line (e.g., a line of a broken line) having a shape of the path 181. The input to edit the original image 110 may include a second input, indicating a selection of the visual object 184, further received within a state in which the first input has been received. In response to the second input, the electronic device 101 may switch from a state 191 to a state 192.

Within the state 192 of FIG. 1, the electronic device 101 may display an edit screen including an edited image 115 for the original image 110 on the display 130. The electronic device 101 may execute an image editing model, based on the input to edit the original image 110, received within the state 191. In order to execute the image editing model, the electronic device 101 may generate one or more prompts associated with the input. In the present disclosure, a prompt may refer, for example, to a natural language (or an ordinary language) sentence to be input to the image editing model. A natural language may refer, for example, to a language used in a daily life of mankind. The prompt may refer, for example, to the natural language sentence binarized based on a binary code such as Unicode (or ASCII code).

For example, within the state 191, in response to the second input indicating the selection of the visual object 184, the electronic device 101 may generate a prompt based on the function of the visual object 184. In response to the second input received after the first input based on an external object moving along the path 181, the electronic device 101 may generate a prompt (e.g., “remove a tree”) to remove a captured subject (e.g., the tree) in a portion of the original image 110 specified by the path 181. The disclosure is not limited thereto. For example, the electronic device 101 may generate a prompt from a speech detected using analysis of an audio signal based on speech-to-text (STT). For example, the electronic device 101 may display, on the display 130, a visual object such as a text box, and directly receive a prompt from a user through the text box. The electronic device 101 may obtain the edited image 115, by executing an image editing model using the prompt.

Referring to FIG. 1, within the state 192 of displaying an edited image including the edited image 115, the electronic device 101 may receive an input to change the edited image 115. For example, the electronic device 101 that receives an input to remove a specific subject (e.g., a cloud) captured by the edited image 115 may obtain or generate an edited image 120 having the specific subject removed from the edited image 115, by executing an image editing model based on the input. Referring to FIG. 1, within a state 193, the electronic device 101 may display the edited image 120 on the display 130, in response to the input.

Within the state 192 of FIG. 1, the electronic device 101 may receive an input to store the edited image 120. Based on the input, the electronic device 101 may generate or store the file 124 including the edited image 120 among the edited image 120 or another image (e.g., the original image 110 and/or the edited image 115) displayed before the edited image 120. For example, the file 124 may include a JPEG file, a high efficiency image file format (HEIF) file, a high efficiency image container (HEIC) file, a portable network graphic (PNG) file, and/or a graphics interchange format (GIF) file.

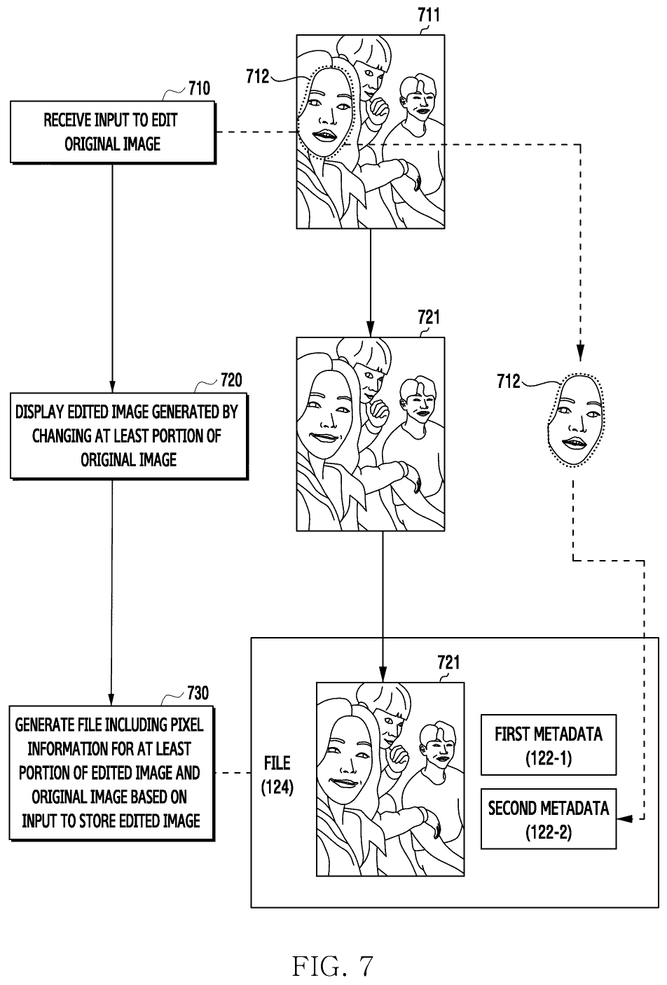

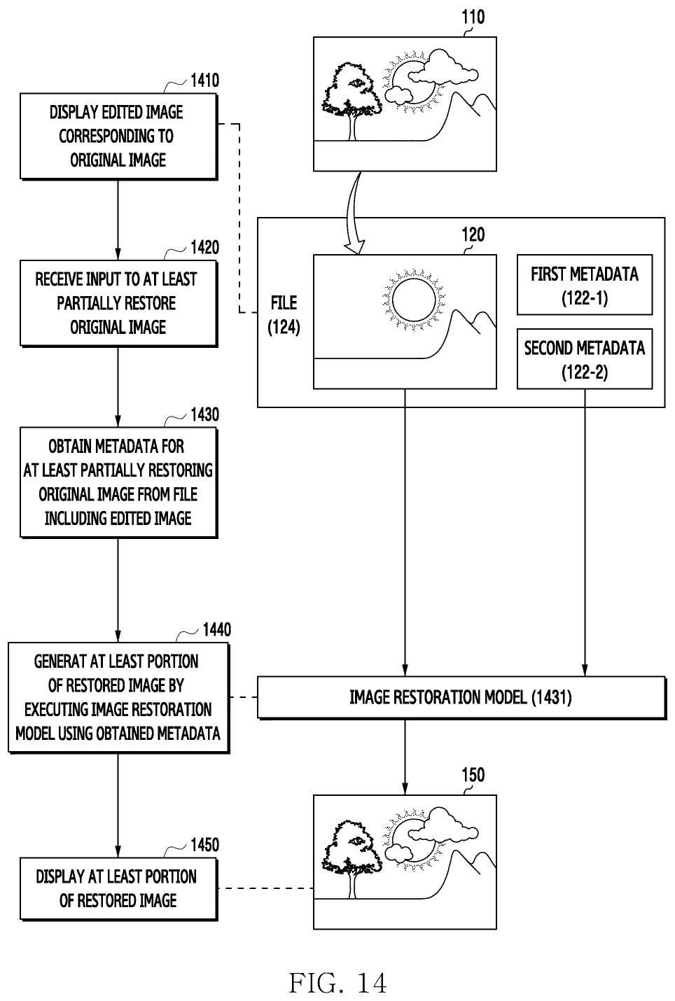

For example, the file 124 may include information for supporting a restoration function to the original image 110 together with the edited image 120 corresponding to the original image 110. The electronic device 101 may add or insert the information into metadata of the file 124. An example operation of the electronic device 101 generating the file 124 that includes the edited image 120 converted from the original image 110 and metadata 122 based on execution of an artificial intelligence model (e.g., a generative artificial intelligence model) such as an image editing model will be described in greater detail below with reference to FIGS. 7 to 13. For example, the electronic device 101 may generate the file 124 that includes only the edited image 120 without the original image 110 and includes compressed information for a restoration function, in order to support the restoration function while reducing the size of the file 124. For example, the electronic device 101 generating the file 124 within the state 193 may discard another image (e.g., the original image 110 and/or the edited image 115) different from the edited image 120 stored in file 124. An example operation of the electronic device 101 that restores the original image 110 using the file 124 will be described with reference to FIG. 14.

Hereinafter, an example hardware configuration of an electronic device 101 according to various embodiments will be described in greater detail with reference to FIGS. 2A and/or 2B.

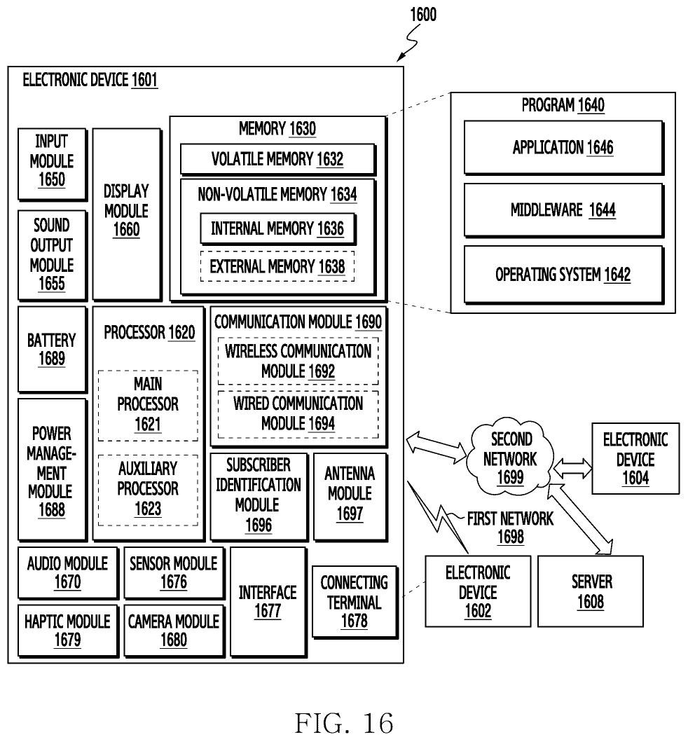

FIGS. 2A and 2B are block diagrams illustrating example configurations of an electronic device according to various embodiments. The electronic device 101 of FIG. 1 may be an example of the electronic device 101 described with reference to FIGS. 2A and/or 2B. Referring to FIGS. 2A and/or 2B, the electronic device 101 may include a processor (e.g., including processing circuitry) 210, memory 215, a display 130, a camera 220, and a communication circuit 225. The number and/or a type of electronic components included in the electronic device 101 is not limited to FIGS. 2A and/or 2B. For example, the electronic device 101 may further include an electronic component described with reference to FIG. 16. For example, a portion (e.g., the camera 220 and/or the communication circuit 225) of the electronic component of FIG. 2A may be excluded from the electronic device 101, or an electronic component not illustrated in FIG. 2A and/or FIG. 2B may be further included in the electronic device 101.

Referring to FIGS. 2A and/or 2B, the electronic devices 101 may have forms such as a laptop personal computer (PC) 101-1, smartphones (e.g., a bar-type smartphone 101-2, a foldable smartphone 101-3, or a slidable (or rollable) smartphone 101-4), a tablet PC 101-5, a head-mounted display (HMD) device 101-6, and other similar computing devices (not illustrated). The electronic device 101 may include a housing that forms the shape (or appearance) of the electronic device 101. The housing of the electronic device 101 may be referred to as a case, and may be formed of plastic, glass, ceramic, fiber composites, metal (e.g., stainless steel, aluminum, and/or titanium), another suitable material, or a combination of two or more of the materials. For example, the housing may be formed using a unibody configuration in which all or a portion of the housing is assembled as a single structure (e.g., the bar-type smartphone 101-2), or may be formed using a plurality of structures (e.g., an inner frame structure, one or more structures forming an outer appearance of a surface of the housing) (e.g., the foldable smartphone 101-3 having a plurality of parts).

For example, the processor 210 may be electrically or operatively (or operably) coupled with another electronic component of the electronic device 101 including the memory 215. For example, the processor 210 being operatively coupled with an electronic component may indicate that the processor 210 is directly connected to another electronic component. For example, the processor 210 being operatively coupled with a first electronic component may indicate that the processor 210 is (indirectly) connected to the first electronic component through a second electronic component of the electronic device 101. For example, the processor 210 being operatively coupled with an electronic component may indicate that a state of the processor 210 is a state capable of controlling the electronic component. For example, the processor 210 being operatively coupled with an electronic component may indicate that an operation of the electronic component is caused based on information, data, a signal, or a command provided from the processor 210. However, the disclosure is not limited thereto.

For example, the processor 210 of the electronic device 101 may include a circuit (e.g., processing circuitry) for processing data based on one or more instructions. The circuit for processing data may include, for example, an arithmetic and logic unit (ALU), a floating point unit (FPU), a field programmable gate array (FPGA), a central processing unit (CPU), a graphic processing unit (GPU), a neural processing unit (NPU), and/or an application processor (AP). For example, the number of processors may be one or more. Processing circuitry of a processor that loads (or fetches) an instruction and performs a calculation corresponding to the loaded instruction may be referred to or may be referenced as a core circuit (or a core). For example, the processor may have a structure of a multi-core processor that includes a plurality of core circuits, such as a dual core, a quad core, a hexa core, or an octa core. A function and/or an operation described with reference to the present disclosure may be performed individually or collectively by one or more processing circuitry included in the processor 210. The processor 210 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

For example, the display 130 of the electronic device 101 may output visualized information (e.g., screens displayed in the states 191, 192, and 193 of FIG. 1) to a user. For example, the display 130 may be configured to visualize information provided from the graphic processing unit (GPU) and/or the processor 210. The display 130 may include a liquid crystal display (LCD), a plasma display panel (PDP), and/or light emitting diodes (LEDs). The LED may include an organic LED (OLED). The display 130 may include a flat panel display (FPD), electronic paper, and/or a flexible display having at least a partially curved shape or having a deformable shape.

For example, the display 130 of the electronic device 101 may include a sensor (e.g., a touch sensor panel (TSP)) for detecting an external object (e.g., a user's finger) on the display 130. For example, based on the TSP, the processor 210 may detect an external object (e.g., an external object dragged along the path 181 within the state 191 of FIG. 1) contacting with the display 130 or floating on the display 130. In response to detecting the external object, the processor 210 may execute a function associated with a specific visual object corresponding to a location of the external object on the display 130 among visual objects displayed on the display 130.

For example, the memory 215 of the electronic device 101 may include a circuit and/or a storage medium for storing data and/or an instruction input to or output from the processor 210. The memory may include, for example, a volatile memory such as a random-access memory (RAM) and/or a non-volatile memory such as a read-only memory (ROM). The non-volatile memory may be referred to as storage. The volatile memory may include, for example, at least one of dynamic RAM (DRAM), static RAM (SRAM), Cache RAM, and pseudo SRAM (PSRAM). The nonvolatile memory may include, for example, at least one of programmable ROM (PROM), erasable PROM (EPROM), electrically erasable PROM (EEPROM), a flash memory, a hard disk, a compact disk, a solid state drive (SSD), and an embedded multi media card (eMMC). The processor 210 of the electronic device 101 may perform a function and/or an operation indicated by instructions, by executing the instructions of the memory 215 in the electronic device 101. For example, when the electronic device 101 includes at least one processor, the at least one processor may be configured to execute the instructions collectively or individually.

For example, the camera 220 of the electronic device 101 may include optical sensors (e.g., a charged coupled device (CCD) sensor and a complementary metal oxide semiconductor (CMOS) sensor) that generate an electrical signal indicating a color and/or brightness of light. The optical sensors included in the camera 220 may be disposed in a form of a 2 dimensional array. The camera 220 may generate 2D frame data corresponding to light reaching the optical sensors of the 2 dimensional array, by obtaining the electrical signal of each of a plurality of optical sensors substantially simultaneously. For example, photo data (e.g., the original image 110 in FIG. 1) captured using the camera 220 may refer, for example, to a 2 dimensional frame data obtained from the camera 220. For example, video data captured using the camera 220 may refer, for example, to a sequence of a plurality of 2 dimensional frame data obtained from the camera 220. In an embodiment, the communication circuit 225 of the electronic device 101 may include hardware to support transmission and/or reception of an electrical signal between the electronic device 101 and an external electronic device (e.g., an external electronic device 250 of FIG. 2B). The communication circuit 225 may include, for example, at least one of a MODEM, an antenna, and an optic/electronic (O/E) converter. The communication circuit 225 may support the transmission and/or reception of the electrical signal based on various types of protocols such as Ethernet, local area network (LAN), wide area network (WAN), wireless fidelity (WiFi), near field communication (NFC), Bluetooth, Bluetooth low energy (BLE), ZigBee, long term evolution (LTE), fifth generation (5G) new radio (NR), sixth generation (6G), and/or above-6G.

According to an embodiment, the electronic device 101 may process a file 124 stored in the memory 215 (e.g., one or more storage mediums in the electronic device 101 such as the volatile memory and/or the nonvolatile memory). For example, the processor 210 may control the display 130, in order to visualize an edited image 120 included in the file 124. The file 124 may include metadata 122 associated with the edited image 120. Within the file 124 having a jpeg format, the edited image 120 and the metadata 122 may be arranged according to a format (e.g., an example format illustrated in FIG. 4) of international standard organization (ISO) referred to as an exchangeable image file (EXIF). The metadata 122 may be included integrally in the file 124, or may be stored in another file and/or a database connected to the file 124.

In an embodiment, the processor 210 of the electronic device 101 may execute a function of at least partially changing the edited image 120 using the metadata 122. The function may include an operation of generating a restored image (e.g., a restored image including a shape and/or content of the original image 110 of FIG. 1) corresponding to the edited image 120 using information included in the metadata 122. The restored image may include content of an original image (e.g., the original image 110 of FIG. 1) corresponding to the edited image 120. The function may include an operation of generating an edited image of an intermediate version between the edited image 120 and the original image using the information included in the metadata 122.

In an embodiment, an artificial intelligence model (e.g., an image editing model 230) for the function may be installed in the electronic device 101. Hereinafter, an artificial intelligence model may refer, for example, to a computational model that simulates or imitates a neural activity of a living organism, and a set of programs for executing the computational model.

In an embodiment, the artificial intelligence model being installed in the electronic device 101 may refer, for example, to a resource (e.g., formulas included in the computational model and weights, parameters, and/or coefficients associated with the formulas) associated with the artificial intelligence model and instructions being stored in the memory 215 for execution of the artificial intelligence model using only the processor 210 of the electronic device 101. When the artificial intelligence model such as the image editing model 230 is installed in the electronic device 101, the processor 210 may independently execute a function of generating the edited image 120 from the original image without an external electronic device. The artificial intelligence model installed in the electronic device 101 to be independently executed by the electronic device 101 may be referred to as an on-device model.

Referring to FIG. 2A, by executing the on-device model (e.g., the image editing model 230) stored in the memory 215, the processor 210 of the electronic device 101 may at least partially change the original image, or generate the file 124 including the edited image 120 generated by at least partially changing the original image. The disclosure is not limited thereto. Referring to FIG. 2B, the electronic device 101 may execute a function of obtaining a changed edited image 120 from the original image by communicating with the external electronic device 250 referred to as a server. For example, the processor 210 may transmit an original image and information (e.g., one or more prompts) required to change the original image to the external electronic device 250 through the communication circuit 225. The processor 210 may transmit the at least a portion of the original image to the external electronic device 250 together with a command (or request) for changing the original image.

Referring to FIG. 2B, the external electronic device 250 may include a processor (e.g., including processing circuitry) 255, a memory 260, and a communication circuit 265. The processor 255, the memory 260, and the communication circuit 265 may be electrically and/or operatively coupled through a communication bus 252. The processor 255, the memory 260, and the communication circuit 265 of the external electronic device 250 may correspond to the processor 210, the memory 215, and the communication circuit 225 of the electronic device 101, respectively. At least a portion of a description of the processor 255, the memory 260, and the communication circuit 265 of the external electronic device 250 that overlaps with the description of the processor 210, the memory 215, and the communication circuit 225 of the electronic device 101 may not be repeated here.

Referring to FIG. 2B, an embodiment in which the image editing model 230 is installed in the external electronic device 250 is illustrated. In an embodiment of FIG. 2B, the processor 255 receiving a signal for changing the original image from the electronic device 101 may execute the image editing model 230 installed in the external electronic device 250. For example, the processor 255 may generate the edited image 120 corresponding to the original image, by executing the image editing model 230 using one or more prompts included in the signal. The processor 255 may transmit the generated edited image 120 (or the signal including the edited image 120) to the electronic device 101 through the communication circuit 265. The processor 210 that receives the edited image 120 through the communication circuit 225 may control the display 130 to display the edited image 120.

As described above, the processor 210 of the electronic device 101 according to an embodiment may generate or display the edited image 120 corresponding to the original image, using the image editing model 230 installed in the electronic device 101 and/or the external electronic device 250. In response to an input indicating storage of the edited image 120, the electronic device 101 may generate or store the file 124 including the edited image 120 among the original image or the edited image 120. Referring to FIGS. 2A and/or 2B, in an example state in which the file 124 is stored, the original image corresponding to the edited image 120 included in the file 124 may be removed from the electronic device 101 (and/or the external electronic device 250). Instead of maintaining the original image, the electronic device 101 may generate or store the metadata 122 including information required to restore the original image. The metadata 122 may be connected (or linked) with the edited image 120. The information stored in the metadata 122 to restore the original image may include at least one of data illustrated in Table 1.

TABLE 1

| Type (or category) of | |
|---|---|
| information | Description |
| Pixel information | Color, brightness, and/or saturation of |
| | at least one pixel of original image |
| One or more first | Prompt input when generating edited |
| prompts | image 120 from original image |
| One or more second | Prompt including one or more words (e.g., |
| prompts | keywords) to describe original image |
| Edge information (or | Information indicating boundary line of |
| edge image) | at least one subject area of original image |
| layout information | Information indicating location, size, |
| | and/or shape of at least one subject |
| | area of original image |
| Global positioning | Information indicating point where |
| system (GPS) | original image is obtained |
| information | |
| Feature Information | Feature vector (e.g., latent vector) and/or |
| | feature points (or key points) for at |
| | least a portion of original image. |

Referring to Table 1, pixel information may indicate color, brightness, and/or saturation of at least one pixel of the original image based on a resolution lower than or equal to a resolution of the original image and/or the edited image 120. Metadata may be stored in another file different from the file 124 including the edited image 120. For example, in case that metadata is stored in another file different from the file 124, information (e.g., link information) indicating a linkage with the other file (or the metadata) may be stored within the file 124. The information may be stored in metadata of the file 124. For example, in case that metadata is stored in another file different from the file 124, the electronic device may manage (e.g., establish and/or release a connection) a connection between the file 124 and the other file using a database and/or a program.

Hereinafter, an example operation of the electronic device 101 that generates the file 124 including the edited image 120 of FIG. 1, 2A, and/or 2B will be described in greater detail with reference to FIG. 3.

FIG. 3 is a flowchart illustrating an example operation of an electronic device that generates an edited image for an original image according to various embodiments. The electronic device 101 of FIGS. 1, 2A, and 2B and/or the processor 210 of FIGS. 2A and/or 2B may perform an operation described with reference to FIG. 3. An order of operations of FIG. 3 is an example, and in an embodiment, the electronic device may perform the operations of FIG. 3 in another order different from the order illustrated in FIG. 3. In an embodiment, the electronic device may perform at least two of the operations of FIG. 3 substantially simultaneously (e.g., multitasking and/or multithread).

Referring to FIG. 3, in operation 310, a processor of the electronic device according to an embodiment may receive an input to edit an original image (e.g., the original image 110 of FIG. 1). The processor may display a screen (e.g., an edit screen) including the original image on a display (e.g., the display 130 of FIG. 1). Through the edit screen, the processor may receive an input of the operation 310. Based on receiving the input, the processor may perform other operations of FIG. 3.

Referring to FIG. 3, in operation 320, the processor of the electronic device according to an embodiment may execute an image editing model (e.g., the image editing model 230 of FIG. 2A and/or FIG. 2B) using a prompt associated with the received input. In case that an image editing model is installed in the electronic device, the processor may perform the operation 320 independently of an external electronic device (e.g., the external electronic device 250 of FIG. 2B). In case that the image editing model is installed in an external electronic device different from the electronic device, the processor may transmit a signal causing execution of the image editing model to the external electronic device. The signal may include information associated with the original image and/or the input of the operation 310.

In order to execute the image editing model of operation 320, the processor may generate one or more prompts associated with the input of the operation 310. The one or more prompts may include one or more natural language sentences describing the input of the operation 310. The processor may generate or obtain an edited image corresponding to the original image of the operation 310, by executing the image editing model using the original image and/or the one or more prompts.

Referring to FIG. 3, in operation 330, the processor of the electronic device according to an embodiment may display an edited image (e.g., the edited image 120 of FIG. 1, FIG. 2A, and/or FIG. 2B) obtained by executing an image editing model. The processor may generate or obtain the edited image of the operation 330 by performing calculations indicated by an image editing model to which the prompt of the operation 320 is input. The electronic device may display the generated edited image on the display.

Referring to FIG. 3, in operation 340, the processor of the electronic device according to an embodiment may store a file (e.g., the file 124 of FIG. 1) including metadata (e.g., the metadata 122 of FIG. 1) including information to restore an original image based on an input to store an edited image. The input of the operation 340 may include an input indicating selection of the visual object 187 of FIG. 1. In response to the input of the operation 340, the electronic device may generate or store a file including the edited image. In response to the input of the operation 340, the electronic device may generate metadata including information to restore the original image 110. The metadata may be included in or inserted into the file including the edited image. The information to restore the original image may include information (e.g., the information in Table 1) required for execution of an image restoration model (e.g., an image restoration model 1431 of FIG. 14).

As described above, according to an embodiment, the electronic device may store metadata including an edited image for an original image and information for restoring the edited image to the original image, after editing the original image using a generative AI model such as an image editing model. For example, the electronic device receiving the input of operation 340 may remove the original image. The information stored in the metadata may be associated (or linked) with at least a portion edited by a user input within the original image. For example, the electronic device may support a function for restoring to the original image, using only a file including the edited image without the original image.

Hereinafter, an example structure of the file generated by the electronic device performing the operation 340 will be described in greater detail with reference to FIG. 4.

FIG. 4 is a diagram illustrating an example structure of a file 124 generated by an electronic device according to various embodiments. The electronic device 101 of FIG. 1, FIG. 2A, and FIG. 2B and/or the processor 210 of FIG. 2A and FIG. 2B may generate or store the file 124 having a structure described with reference to FIG. 4. The file 124 of FIG. 4 may be generated by the electronic device 101 that performs the operations of FIG. 3.

In an embodiment, within the file 124, an edited image 120 and metadata (e.g., the metadata 122 of FIG. 1) may be arranged based on an EXIF format. Referring to FIG. 4, an example structure of the file 124 based on the EXIF format is illustrated. The file 124 may start from a segment in which a designated value indicating a start (e.g., Start Of Image) of the file 124 is stored. After the segment, one or more APPlication segments (e.g., APP1 and APP2) may be formed within the file 124. The application segment of the file 124 may include an APP1 Marker indicating a start of the application segment and an APP1 Length of the application segment. The application segment of the file 124 may include an EXIF identifier code, a tagged image file format (TIFF) header, and image file directory (IFD) values for the application segment. For example, a zeroth IFD value may include information associated with an image (e.g., the edited image 120) in the file 124 (e.g., a generation time of the file 124). For example, a first IFD value may include a thumbnail image corresponding to the file 124. Metadata of the file 124 may be stored in the application segment of the file 124.

The file 124 based on the EXIF format may further include, after one or more application segments, a Define-Quantization-Tables segment, a Define-Huffman-Tables segment (DHT), a Define-Restart-Interval segment (DRI), a Start of Frame (SOF) segment, and/or a Start-Of-Scan (SOS) segment. After the SOS segment, the file 124 may include compressed data indicating the edited image 120. At an end point of the file 124, a designated value indicating an End of Image of the file 124 may be stored.

Hereinafter, a screen (e.g., an edit screen) displayed by the electronic device to generate the file 124 of FIG. 4 will be described in greater detail with reference to FIG. 5.

FIG. 5 is a diagram illustrating an example operation of an electronic device 101 for displaying an edit screen on a display 130 according to various embodiments. The electronic device 101 of FIG. 1, FIG. 2A, and FIG. 2B and/or the processor 210 of FIG. 2A and/or FIG. 2B may perform an operation described with reference to FIG. 5. The operation of the electronic device 101 described with reference to FIG. 5 may be associated with at least one (e.g., the operation 310) of the operations of FIG. 3.

Referring to FIG. 5, different states 501, 502, 503, and 504 of the electronic device 101 displaying a screen including an original image 110 are illustrated. For example, within a state 501, the electronic device 101 may display the screen including the original image 110 based on execution of a software application (e.g., a gallery application) for browsing images and/or videos stored in memory (e.g., the memory 215 of FIG. 2A and/or FIG. 2B). The screen displayed within the state 501 may further include the original image 110 and a thumbnail image 511 corresponding to the original image 110. In case that a plurality of images including the original image 110 are stored in the electronic device 101, the electronic device 101 may display thumbnail images respectively corresponding to other images different from the original image 110 next to the thumbnail image 511 (e.g., left and/or right of the thumbnail image 511 within the screen).

Within the state 501, the electronic device 101 may display a visual object 512 associated with a function of displaying an edit screen for the original image 110 on the display 130. Referring to FIG. 5, an example visual object 512 including a designated icon (or a designated image) such as a pencil is illustrated, but the disclosure is not limited thereto. Within the state 501, in response to an input to select the visual object 512, the electronic device 101 may switch to a state 502.

Within an example state 502 of FIG. 5, the electronic device 101 may display an edit screen including the original image 110. Within the state 502, the electronic device 101 may display, on the display 130, visual objects 521, 522, 523, 524, and 525 respectively associated with various functions of changing the original image 110. For example, a visual object 521 may be associated with functions for editing the original image 110 using an artificial intelligence model. For example, a visual object 522 may be associated with functions for cropping and/or rotating the original image 110. For example, a visual object 523 may be associated with functions for changing a color of the original image 110. For example, a visual object 524 may be associated with functions for changing brightness and/or saturation of the original image 110. For example, a visual object 525 may be associated with a function for combining another image, referred to as a sticker, on the original image 110.

Referring to FIG. 5, within the example state 502 in which the visual object 522 is selected, the electronic device 101 may display visual objects associated with each of the functions for cropping and/or rotating the original image 110 in an area 526 of the display 130. In response to an input associated with any one of the visual objects displayed in the area 526, the electronic device 101 may crop or rotate (e.g., tilting) the original image 110. Within the state 502, the electronic device 101 may display a visual object 528 associated with a function for storing the original image 110 (or an edited image changed by the input) being displayed within the state 502. For example, the visual object 528 including designated text, such as “save,” is illustrated, but the disclosure is not limited thereto. Within the state 502, the electronic device 101 may display, on the display 130, a visual object 527 for restoration to the original image 110. For example, the visual object 527 including designated text, such as “restore original”, is illustrated, but the disclosure is not limited thereto.

The visual object 521 displayed within the example state 502 of FIG. 5 may be associated with a function for restoring the original image 110 using an artificial intelligence model (e.g., the image editing model 230 of FIGS. 2A and 2B). The electronic device 101 that receives an input to select the visual object 521 may switch from the state 502 to the state 503. Within the state 503, the electronic device 101 may display, within an area 531, visual objects 532, 533, 534, and 535 associated with various functions associated with the artificial intelligence model. For example, a visual object 532 may be associated with a function for at least partially removing content of the original image 110 using the artificial intelligence model. For example, a visual object 533 may be associated with a function for dividing or cropping at least a portion of the original image 110 using an artificial intelligence model. For example, a visual object 534 may be associated with a function for changing a color of at least a portion of the original image 110 to a specific color associated with a user input, using the artificial intelligence model. For example, a visual object 535 may be associated with a function for adjusting a color distribution of the original image 110 using the artificial intelligence model.

Within an example state 503 of FIG. 5, in response to an input to select the visual object 532, the electronic device 101 may switch to a state 504. The states 191, 192, and 193 of FIG. 1 may correspond to the state 504 of FIG. 5. The electronic device 101 may display, on the display 130, visual objects 182, 183, and 184 corresponding to each of functions of removing a shadow, reflected light, and/or a subject, expressed by the original image 110.

Referring to FIG. 5, as shown in states 502, 503, and 504, the electronic device 101 may display edit screens for executing various functions for editing the original image 110. Based on an input received within the states 502, 503, and 504, the electronic device 101 may generate or display an edited image corresponding to the original image 110. The electronic device 101 may generate or store a file (e.g., the file 124 of FIG. 1) including the edited image, in response to an input (e.g., an input to select any one of visual objects 187 and 528) for storing the edited image. The file may include information associated with the original image 110 corresponding to an edited image, together with the edited image.

Referring to FIG. 5, according to an embodiment, the electronic device 101 may display a pop-up window 541 providing an option for information to be stored in a file together with an edited image, in response to an input (e.g., an input indicating a selection of the visual object 187) for storing the edited image. Referring to an example pop-up window 541 of FIG. 5, the electronic device 101 may display the pop-up window 541 including a visual object 544 for starting generation of a file. The electronic device 101 may display a pop-up window 541 including a visual object 545 for canceling generation of a file. Visual objects 544 and 545 having a shape of a button are illustrated, but the shape of the visual objects 544 and 545 is not limited thereto. In response to an input indicating a selection of the visual object 544, the electronic device 101 may generate or store a file including the edited image. When generating a file including the edited image, the electronic device 101 may add information for the restoration of the original image 110 into the file (e.g., as at least portion of metadata of the file), using an option provided through the pop-up window 541 and adjustable by a user.

Referring to FIG. 5, the electronic device 101 may display, on the display 130, a visual object 542 for adjusting whether to generate the file including the information for restoring the original image 110. The visual object 542 having a shape of a toggle button is illustrated, but the disclosure is not limited thereto, and the visual object 542 may have another shape such as a radio button. An input associated with the visual object 542 may include an input that switches (or toggles) between a first mode of limiting the file not to include the information for restoring the original image 110 and a second mode including the information for restoring the original image 110 to the file.

Referring to FIG. 5, the electronic device 101 may display, on the display 130, a visual object 543 for adjusting accuracy of information to be stored together with a file. The accuracy may be associated with a difference between a restored image to be generated using the information and the original image 110. For example, since a file to be generated by the electronic device 101 does not fully include the original image 110, the restored image to be generated using information included in the file may not fully match the original image 110. According to an embodiment, the electronic device 101 may provide an option for adjusting accuracy of information to be stored in a file using the visual object 543. The visual object 543 having a shape of a drop-down menu is illustrated, but the disclosure is not limited thereto. The visual object 543 may have another shape such as a spinner, a progress bar, and/or a slider.

In an embodiment, as the accuracy increases, a size of information to be stored in a file to restore the original image 110 may increase. For example, a user of electronic device 101 may reduce the accuracy by controlling the visual object 543 to reduce or save the size of the file. The visual object 543 for controlling accuracy using designated text such as “high”, “intermediate”, and “low” is illustrated, but the disclosure is not limited thereto, and the electronic device 101 may receive a numerical value (e.g., a numerical value having a unit of percent) indicating accuracy through the pop-up window 541. The electronic device 101 may generate or store information to be used to restore the original image 110, using the received numerical value (or accuracy selected by the visual object 543).

For example, a file may include information for restoring the original image 110 using only an edited image without the original image 110. The information may be stored in metadata (e.g., the metadata 122 of FIG. 1) of the file. For example, when an artificial intelligence model that is executed to restore the original image 110 is executed, the information stored in the file may include information (e.g., the information in Table 1) for changing from the edited image to the original image 110.

Hereinafter, an image editing model executed by the electronic device 101 according to an embodiment that receives an input to edit the original image 110 will be described in greater detail with reference to FIGS. 6A to 6F.

FIGS. 6A, 6B, 6C, 6D, 6E, and 6F are diagrams illustrating example structures of an image editing model (e.g., the image editing model 230 of FIG. 2A and/or FIG. 2B) executed by an electronic device according to various embodiments. The electronic device 101 of FIG. 1, FIG. 2A, and FIG. 2B and/or the processor 210 of FIG. 2A and/or FIG. 2B may execute or utilize an artificial intelligence model described with reference to FIG. 6A to FIG. 6F as an image editing model. The image editing model may be referred to as a super resolution model in terms of editing a high-resolution original image (e.g., the original image 110 of FIG. 1). The image editing model may be referred to as a generative artificial intelligence model in terms of generating an edited image that includes content not included in an original image. The image editing model may be referred to as an auto encoder based model based on a structure used to implement the model. The image editing model may be referred to as a prompt model in terms of changing an original image using a prompt, or generating an edited image corresponding to the original image.

In the present disclosure, a generative artificial intelligence model, which may be an artificial intelligence model trained using a set (e.g., a training set and/or a training database) of a plurality of images, may refer, for example, to an artificial intelligence model trained to be capable of generating and outputting a new image approximated to the plurality of images.

Referring to FIG. 6A, artificial intelligence models (e.g., a generator model 611 and discriminator model 612) that are trained based on generative advertising networks (GAN) are illustrated. The generator model 611 may be trained to output a generated image 614 from input data (e.g., a latent vector 613 in a latent space). The discriminator model 612 may be trained to output a parameter R (e.g., a probability that an input image is generated by the artificial intelligence model) indicating whether an input image (e.g., the generated image 614 generated by the generator model 611 and/or an actual image 615) is generated by the artificial intelligence model.

For example, when executing the discriminator model 612 using the actual image 615, the electronic device may obtain, from the discriminator model 612, a parameter indicating that an input image (in the example, the actual image 615) of the discriminator model 612 is not generated by the artificial intelligence model. For example, when executing the discriminator model 612 using the generated image 614, the electronic device may obtain, from the discriminator model 612, a parameter indicating that an input image (in the example, the generated image 614) of the discriminator model 612 is generated by the artificial intelligence model.

In an embodiment, the generator model 611 may be trained such that the generated image 614 generated by the generator model 611 is determined to not be generated by the artificial intelligence model by the discriminator model 612. For example, the generator model 611 may be trained to reduce a probability that an input image output by the discriminator model 612 is generated by the artificial intelligence model. Training of the generator model 611 and/or the discriminator model 612 may be repeatedly performed for a plurality of generated images including the generated image 614. Training of the generator model 611 and/or the discriminator model 612 may be terminated when the generator model 611 is determined to not to be generated by the artificial intelligence model by the discriminator model 612. For example, training of the generator model 611 may be terminated when a generated image 614 having content, composition, and/or a color distribution similar to the actual image 615 is generated. A trained generator model 611 may be used as an image editing model (e.g., the image editing model 230 of FIGS. 2A and/or 2B) for at least partially changing an original image.

Referring to FIG. 6B, an artificial intelligence model having a structure of an auto encoder (AE) is illustrated. The artificial intelligence model may include an encoding model 621 and a decoding model 622. The artificial intelligence model having the structure of the auto encoder and including the encoding model 621 and the decoding model 622 may be trained to reduce (e.g., to generate the same generated image 625 as the input image 623) a difference between an input image 623 input to the encoding model 621 and a generated image 625 output from the decoding model 622.

When the artificial intelligence model having the structure of the auto encoder is executed, a dimension reduction based on the encoding model 621 may be performed. For example, feature information (e.g., a latent vector 624) having a size less than the size of the input image 623 may be output from the encoding model 621. The latent vector 624 is implicit information output from the encoding model 621, and the encoding model 621 may be trained to output the latent vector 624 having different elements with respect to images input to the encoding model 621.

When the artificial intelligence model having the structure of the auto encoder is executed, dimensional expansion based on the decoding model 622 may be performed. For example, the decoding model 622 may be trained to output the generated image 625 from feature information such as the latent vector 624. The decoding model 622 may be trained to output the generated image 625 having the same resolution as the input image 623 and/or the same size as the input image 623. For example, the artificial intelligence model having the structure of the auto encoder may be trained to reduce or minimize the difference between the input image 623 and the generated image 625. After training, at least a portion of the artificial intelligence model may be used as an image editing model for changing an original image.

Referring to FIG. 6C, an artificial intelligence model having a structure of a variational autoencoder (VAE) is illustrated. The artificial intelligence model having the structure of the VAE may include an encoding model 631 and a decoding model 632. Within the artificial intelligence model having the structure of the VAE, the encoding model 631 may be trained to output a latent vector 636 including a mean vector 634 and a standard deviation vector 635 for an input image 633 (e.g., when training, at least one image included in a set of images set for training).

In an embodiment, the decoding model 632 may be trained to generate a generated image 637 using a probability distribution having a feature of the input image 633 as a probability variable, based on the latent vector 636. For example, when trained using a set of images for training, the decoding model 632 may be trained to perform dimensional expansion based on a probability distribution of features included in the images. After the training, using a probability distribution indicated by the latent vector 636, the decoding model 632 may output a generated image 637 expressing one or more features indicated by the latent vector 636. After the training, at least a portion of the artificial intelligence model having the structure of the VAE including the decoding model 632 may be used as an image editing model for changing an original image.

Referring to FIG. 6D, an artificial intelligence model having a structure of a diffusion model (DM) is illustrated. The artificial intelligence model having the structure of the DM may be trained to compensate for and/or restore a distortion (e.g., a distortion based on noise and/or masking) of an image included in a set of images for training when trained using the set. For example, a corrupted version image (e.g., an image 642-1 fully contaminated by noise) included in the set may be input to the artificial intelligence model. Based on execution of the artificial intelligence model, a restored image 642-3 may be generated from the corrupted version image 642-1. A process of an artificial intelligence model generating the restored image 642-3 from the corrupted version image 642-1 may be referred to as denoising.

Referring to FIG. 6D, the artificial intelligence model having the structure of the DM may include an artificial intelligence model (e.g., a transformer 641) for natural language processing. For example, by executing the transformer 641 using a prompt 643 (e.g., a natural language phrase and/or a natural language sentence such as “An image of the face of a man”), information 644 capable of being input to an artificial intelligence model for denoising may be generated. Information 644 may include vectors (or tokens) generated from each of words (or morphemes) included in the prompt 643, based on tokenization.

For example, as the information 644 is input to the artificial intelligence model for denoising, the artificial intelligence model may be trained to generate the restored image 642-3 including a feature indicated by the prompt 643 from the corrupted version image 642-1. For example, the information 644 may be input to the artificial intelligence model when an intermediate version image 642-2 is generated from the corrupted version image 642-1. The information 644 input to the artificial intelligence model may function as a condition for generating the intermediate version image 642-2. After training is completed, at least a portion of the artificial intelligence model including the transformer 641 may be used as an image editing model for obtaining an edited image from an original image.

Referring to FIG. 6E, an artificial intelligence model having a structure of a latent diffusion model (LDM) is illustrated. The artificial intelligence model having the structure of the LDM may have a structure in which a structure based on a contrastive language-image pre-training model (CLIP) and/or VAE is coupled with the artificial intelligence model having the structure of the DM of FIG. 6D. The artificial intelligence model having the structure of the LDM may include a text encoding model 652 that performs tokenization of a prompt 651. The text encoding model 652 may have a structure based on the CLIP. Information 653 corresponding to the prompt 651 may be generated from the text encoding model 652. The information 653 may include vectors (or tokens) corresponding to each of words (or morphemes) included in the prompt 651, based on tokenization.

Referring to FIG. 6E, the artificial intelligence model having the structure of the LDM may include a U-model 654 (or U-Net), and may include a scheduler 657 for repeatedly performing image conversion based on the U-model 654. The scheduler 657, which is a program based on a scheduling algorithm, may be configured to repeatedly perform to input of an input image 655 to the U-model 654, and input of an output image 656 output from the U-model 654 as the input image 655 for the U-model 654 again.

Referring to FIG. 6E, when the U-model 654 is executed, the information 653 corresponding to the prompt 651 may be input to the U-model 654 as a condition for generating the output image 656. The U-model 654 may be trained to perform denoising for the input image 655, similar to the artificial intelligence model having the structure of the DM of FIG. 6D. The U-model 654 may be trained to perform denoising based on a condition set by the information 653.

Referring to FIG. 6E, an artificial intelligence model having the structure of the LDM may include a decoding model 658 for generating a generated image 659 to be provided as a result of generating an image from the output image 656 of the U-model 654. For example, the output image 656 finally output from the U-model 654 by the scheduler 657 may be converted into the generated image 659 by the decoding model 658. For example, based on execution of the decoding model 658, a resolution of the output image 656 may be increased, or a size of the output image 656 may be expanded. The artificial intelligence model having the structure of the LDM of FIG. 6E may be used as an image editing model for editing associated with an original image.

Referring to FIG. 6F, an artificial intelligence model having a structure of a layout diffusion model is illustrated. The artificial intelligence model of FIG. 6F may have a structure deformed from the structure of the LDM of FIG. 6E so that layout information 661 may be input. The layout information 661 may be set to indicate types of subjects respectively associated with portions of the generated image 659, in order to guide a layout of the generated image 659. For example, the layout information 661 may include data (e.g., a coordinate of a vertex of a bounding box, a width and a height of the bounding box) indicating bounding boxes indicating portions of the generated image 659 in which subjects are located. For example, the layout information 661 may include pixel wise information indicating subjects expressed in each portion of the generated image 659. For example, the layout information 661 may include an image in which a figure of a designated color corresponding to a specific subject is drawn.

The U-model 654 of the artificial intelligence model having the structure of the layout diffusion model may be trained to process the layout information 661 based on an attention operation. For example, based on a query-key-value (QKV) attention algorithm, the layout information 661 may be synthesized with other information within the U-model 654. Based on the synthesis, when the output image 656 is generated from the input image 655, the layout information 661 may function as a condition associated with the output image 656. The artificial intelligence model having the structure of the layout diffusion model of FIG. 6F may be used as an image editing model for generating an edited image using an original image.

As described above, when generating an edited image (e.g., the edited image 120 of FIG. 1) by at least partially changing an original image (e.g., the edited image 120 of FIG. 1), an image editing model having various structures may be used. Hereinafter, an example operation of an electronic device that generates an edited image by changing the original image using the artificial intelligence model described with reference to FIGS. 6A to 6F will be described in greater detail with reference to FIGS. 7 to 13.

FIG. 7 is a diagram illustrating an example operation of an electronic device that generates a file 124 including pixel information for at least a portion (e.g., a portion 712) of an original image 711 different from an edited image 721 according to various embodiments. The electronic device 101 of FIG. 1, FIG. 2A, and FIG. 2B and/or the processor 210 of FIG. 2A and/or FIG. 2B may perform an operation(s) described with reference to FIG. 7. At least one of operations of FIG. 7 may be associated with the operations of FIG. 3, or may be performed similarly. An order of operations of FIG. 7 is and example, and in an embodiment, the electronic device may perform the operations of FIG. 7 in another order different from the order illustrated in FIG. 7. In an embodiment, the electronic device may perform at least two the operations of FIG. 7 substantially simultaneously.

Referring to FIG. 7, in operation 710, a processor of the electronic device according to an embodiment may receive an input to edit an original image 711. The processor may receive an input of the operation 710 through an edit screen displayed on a display (e.g., the display 130 of FIG. 1). For example, within a state of displaying visual objects corresponding to functions for editing the original image 711, such as the edit screens illustrated in FIG. 1 and/or FIG. 5, the processor may receive an input to select any one of the visual objects. The processor receiving the input of the operation 710 may perform other operations of FIG. 7. The input of the operation 710 may include the input of the operation 310 of FIG. 3. Referring to FIG. 7, in a state of displaying the original image 711 in which a plurality of people is captured, the processor may receive an input to change a facial expression captured by the original image 711.

Referring to FIG. 7, in operation 720, the processor of the electronic device according to an embodiment may display an edited image 721 generated by changing at least a portion (e.g., the portion 712) of the original image 711. The processor may generate or display the edited image 721 corresponding to the original image 711 by performing the operations 320 and 330 of FIG. 3. For example, the processor may obtain the edited image 721 by executing an image editing model (e.g., the image editing model 230 of FIGS. 2A and/or 2B) using a prompt associated with the input of the operation 710.

Referring to FIG. 7, in case of receiving the input to change the facial expression captured by the original image 711, the processor may generate a prompt (e.g., “change an expression of the nearest person to a smiling expression”) indicating a change of the expression. By executing the image editing model using the prompt, the processor may obtain or generate the edited image 721 including content (e.g., a face with a smiling expression) corresponding to the prompt. The processor may display the edited image 721 on an edit screen, in response to the input of the operation 710.

Referring to FIG. 7, in operation 730, the processor of the electronic device according to an embodiment may generate a file 124 including pixel information for the edited image 721 and at least a portion (e.g., the portion 712) of the original image 711, based on an input to store the edited image 721. For example, while displaying the edited image 721 based on the operation 720, the processor may receive an input to store the edited image 721. Based on receiving the input, the processor may generate the file 124 including the edited image 721.

The processor may store, in first metadata 122-1 of the file 124, history information on the edited image 721 stored in the file 124. The history information may indicate one or more edit actions performed while generating the edited image 721 from the original image 711. For example, in an example case of FIG. 7 in which the edited image 721 is obtained by changing the portion 712 of the original image 711, the processor may store, in the first metadata 122-1, data indicating a location, a shape, and/or a size of the portion. For example, the processor may add or store, in the first metadata 122-1, a value (or a flag) indicating whether the edited image 721 is generated by a generative artificial intelligence model (e.g., the image editing model 230 of FIG. 2A and FIG. 2B). For example, the processor may add or store, in the first metadata 122-1, a time (e.g., a date and/or a timestamp) when the edited image 721 is generated, and area information indicating the portion 712 of the original image 711 different from the edited image 721.

Referring to FIG. 7, in a state of generating the edited image 721 by changing the portion 712 of the original image 711, the processor may generate pixel information indicating a color of pixels corresponding to the portion 712, based on receiving the input of the operation 730. The processor may store the pixel information in second metadata 122-2 of the file 124 including the edited image 721. For example, the pixel information stored in the second metadata 122-2 may express content of the portion 712 of the original image 711 different from the edited image 721. For example, the pixel information stored in the second metadata 122-2 may include colors (or values) of pixels included in the portion 712 of the original image 711. For example, the pixel information may include a color distribution and/or a brightness distribution of the portion 712.

In the present disclosure, a metadata term may be numbered, such as the first metadata 122-1 and the second metadata 122-2. The numbered metadata term may be used for a logical classification according to content, a purpose, a type, and/or a format of metadata. For example, all numbered metadata may be stored within a logical area set to store metadata within the file 124. The disclosure is not limited thereto, and numbered metadata may be separated and stored within the file 124 (or a storage medium for storing metadata).

In an embodiment, pixel information stored in the second metadata 122-2 may be based on a resolution and/or a size of the original image 711. For example, the pixel information may include pixels that are one-to-one matched with pixels corresponding to the portion 712 of the original image 711. For example, the pixel information may indicate a color distribution of pixels in the original image corresponding to the portion 712, using a resolution lower than the resolution of the original image 711 or a size smaller than the size of the portion 712 of the original image 711.

As described above, in case of generating the edited image 721 by changing at least a portion of the original image 711, since an entire original image 711 is not stored in the file 124, and pixel information corresponding to the portion 712 of the original image 711 is stored, the file 124 may further include information for restoring and/or displaying the original image 711 while having a relatively small size. The file 124 including the second metadata 122-2 including pixel information may be used to obtain the portion 712 to be coupled to the edited image 721 when a function of restoring the original image 711 is executed. The electronic device executing the function may generate or output a restored image, by coupling the portion 712 to the edited image 721. A location of the portion 712 coupled to the edited image 721 may be set based on history information included in the first metadata 122-1.

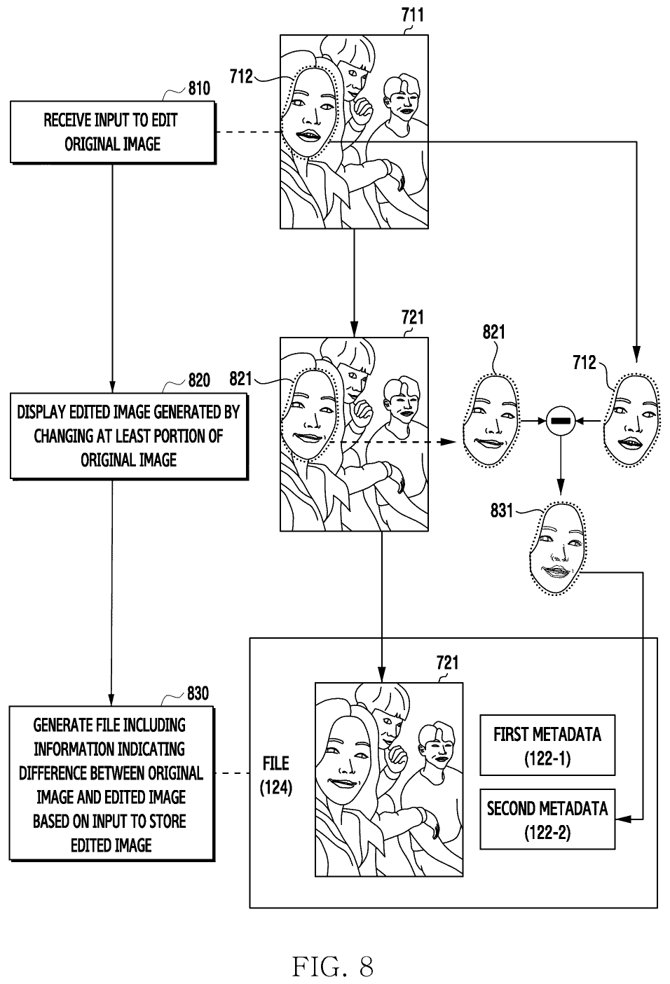

FIG. 8 is a diagram illustrating an example operation of an electronic device that generates a file 124 using pixel differences between an edited image 721 and an original image 711 according to various embodiments. The electronic device 101 of FIG. 1, FIG. 2A, and FIG. 2B and/or the processor 210 of FIG. 2A and/or FIG. 2B may perform an operation described with reference to FIG. 8. At least one of operations of FIG. 8 may be associated with the operations of FIG. 3, or may be performed similarly. An order of operations of FIG. 8 is an example, and in an embodiment, the electronic device may perform the operations of FIG. 8 in another order different from the order illustrated in FIG. 8. In an embodiment, the electronic device may perform at least two the operations of FIG. 8 substantially simultaneously.

Referring to FIG. 8, in operation 810, a processor of the electronic device according to an embodiment may receive an input to edit an original image 711. The processor may receive an input of the operation 810 while displaying an edit screen including the original image 711. The input may include the input of the operation 310 of FIG. 3 and/or the input of the operation 710 of FIG. 7. Referring to FIG. 8, similar to FIG. 7, it is assumed that the processor receives an input to change a facial expression captured by the original image 711.

Referring to FIG. 8, in operation 820, the processor of the electronic device according to an embodiment may display the edited image 721 generated by changing at least a portion (e.g., a portion 712) of the original image 711. The processor may obtain or generate the edited image 721 by performing the operations 320 and 330 of FIG. 3 and/or the operation 720 of FIG. 7. The processor that obtains the edited image 721 may display the edited image 721 on a display (e.g., the display 130 of FIG. 1). For example, the processor may switch or replace the original image 711 included in an edit screen with the edited image 721.

Referring to FIG. 8, in operation 830, the processor of the electronic device according to an embodiment may generate the file 124 including information 831 indicating a difference between the original image 711 and the edited image 721, based on an input to store the edited image 721. For example, the processor may obtain the information 831 by comparing a portion 821 of the edited image 721 different from the original image 711 and the portion 712 of the original image 711 corresponding to the portion 821. For example, the information 831 may indicate a color difference (e.g., a pixel-wise color difference and/or a pixel-wise value difference) of portions 821 and 712. The processor may obtain or calculate the information 831 including difference values of values (or colors) of pixels of the portions 821 and 712. For example, based on receiving an input of the operation 830, the processor may generate the information 831 indicating a pixel difference between the original image 711 and the edited image 721.

Referring to FIG. 8, the processor generating the information 831 may generate or store the file 124 including the edited image 721 and the information 831. Within the file 124, the information 831 may be stored in second metadata 122-2 as information to be used to restore the original image 711. The processor may store, in the first metadata 122-1, data (e.g., a size, a location, and/or a shape of the portion 712 within the original image 711) indicating the portion of the original image 711 that is changed, by generating the edited image 721.

As described above, the processor may generate the file 124 including the information 831, in order to support a function of restoring to the original image 711, while reducing a size of the file 124. For example, when a restoration function is executed based on the file 124, the processor may change colors (or values) of pixels of the edited image 721 corresponding to the portion 712 indicated by the first metadata 122-1, using the information 831.

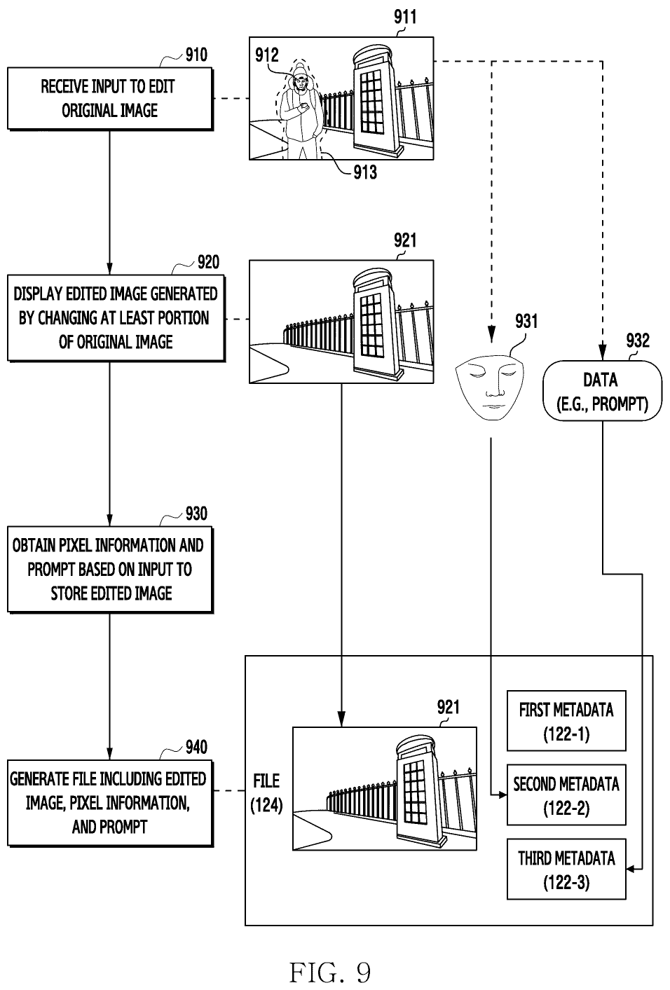

FIG. 9 is a diagram illustrating an example operation of an electronic device that generates a file 124 including pixel information 931 and/or data according to various embodiments. The electronic device 101 of FIG. 1, FIG. 2A, and FIG. 2B and/or the processor 210 of FIG. 2A and/or FIG. 2B may perform an operation described with reference to FIG. 9. At least one of operations of FIG. 9 may be associated with the operations of FIG. 3, or may be performed similarly. An order of operations of FIG. 9 is an example, and in an embodiment, the electronic device may perform the operations of FIG. 9 in another order different from the order illustrated in FIG. 9. In an embodiment, the electronic device may perform at least two the operations of FIG. 9 substantially simultaneously.

Referring to FIG. 9, in operation 910, a processor of the electronic device according to an embodiment may receive an input to edit an original image 911. The processor may receive an input of the operation 910 through an edit screen, which is displayed on a display (e.g., the display 130 of FIG. 1) and includes the original image 911. The input of the operation 910 may include the input of the operation 310 of FIG. 3, the input of the operation 710 of FIG. 7, and/or the input of the operation 810 of FIG. 8. Referring to FIG. 9, in a state in which an original image 911 expressing a landscape including a person, a phone booth, and a steel fence is displayed, it is assumed that the processor detects an input to remove the person.

Referring to FIG. 9, in operation 920, the processor of the electronic device according to an embodiment may display an edited image 921 generated by changing at least a portion of the original image 911. The processor may obtain or generate the edited image 921, by performing the operations 320 and 330 of FIG. 3, the operation 720 of FIG. 7, and/or the operation 820 of FIG. 8. For example, in an example case of receiving an input to remove a person, the processor may generate a prompt (e.g., “remove a person included in an image”) describing the input. The processor may obtain or generate the edited image 921 of the operation 920 from an image editing model (e.g., the image editing model 230 of FIG. 2A and/or FIG. 2B) executed using a generated prompt. Based on obtainment of the edited image 921, the processor may replace the original image 911 displayed on the display 130 with the edited image 921.

Referring to FIG. 9, in operation 930, the processor of the electronic device according to an embodiment may obtain the pixel information 931 and a prompt (e.g., data 932) based on an input to store the edited image 921. For example, in a case of generating the edited image 921 by changing a portion associated with a person within the original image 911, the portion may be divided into a main area 912 and a sub area 913. For example, a changed portion of the original image 911 for the edited image 921 may be divided into the main area 912 and the sub area 913. Referring to FIG. 9, a portion associated with a person's face may be divided into the main area 912, and another portion associated with a person's clothes may be divided into the sub area 913. The edited image 921 to be stored in the file 124 may include content different from the content of the main area 912 and the sub area 913 of the original image 911.

For example, the content of the main area 912 and the sub area 913 of the original image 911 may not be maintained in the edited image 921. In an example case of FIG. 9, a restored image generated from the edited image 921 may include the content (e.g., a person) of the main area 912 and the sub area 913 again. Since a probability that a user viewing the restored image will focus on a restored face is high, the portion associated with the person's face may be divided into the main area 912, and another portion different from the main area may be divided into the sub area 913.

According to an embodiment, the electronic device may obtain the pixel information 931 corresponding to the main area 912 in order to relatively accurately restore the main area 912 of the original image 911. The pixel information 931 may include colors (or values) of pixels included in the main area 912 of the original image 911. For example, the pixel information 931 may indicate a color distribution and/or a brightness distribution of the main area 912, based on a size and/or a resolution of the main area 912. For example, the pixel information 931 may indicate the color distribution and/or the brightness distribution of the main area 912 based on a lower resolution than the main area 912 and/or a smaller size than the main area 912.

According to an embodiment, the electronic device may generate or obtain the data (e.g., a prompt) 932 describing content of the sub area 913 in order to reduce a size of the file 124. In an example case of FIG. 9, the data 932 may include natural language sentences (e.g., “A person is wearing a black backpack. The person is wearing a winter jumper with a brown fur hat attached and black training pants. The person's right arm is bent toward a body, and the person's right hand is located around a chest. The person is holding a black cellphone with a right hand. The person's left hand is located inside a pants pocket. The person is wearing a fur hat.”) describing clothes of the person excluded from the edited image 921.

Referring to FIG. 9, in operation 940, the processor of the electronic device according to an embodiment may generate the file 124 including the edited image 921, the pixel information 931, and a prompt. In an example case of FIG. 9, the processor may generate or may store the file 124 including first metadata 122-1 including history information of generating the edited image 921, second metadata 122-2 including the pixel information 931, and the data 932. The file 124 may display the edited image 921 among the original image 911 or the edited image 921. When generating the file 124, the processor may discard or remove the original image 911.

As described above, the processor generating the edited image 921 by changing a portion (e.g., a portion including the main area 912 and the sub area 913) of the original image 911 may generate the pixel information 931 of the main area 912 and the data 932 associated with the sub area 913, based on receiving an input to store an edited image. The main area 912 and the sub area 913 may be divided by content of the portion of the original image 911. The processor may support restoration of the original image 911 using the edited image 921 of the file 124, by generating the file 124 including all of the pixel information 931 and the data 932. For example, information (e.g., the data 932) associated with an artificial intelligence model (e.g., an image restoration model) to be executed to restore the original image 911 may be generated by the processor, and the file 124 including the information may be stored.

The electronic device may restore the original image 911, using the file 124 generated based on operation described with reference to FIG. 9. For example, within the edited image 921 included in the file 124, the electronic device may couple a partial image indicated by the pixel information 931 in the second metadata 122-2 to an area corresponding to the main area 912. For example, the electronic device may change an area corresponding to the sub area 913 within the edited image 921, using an image editing model executed using the data 932 indicated by third metadata 122-3.

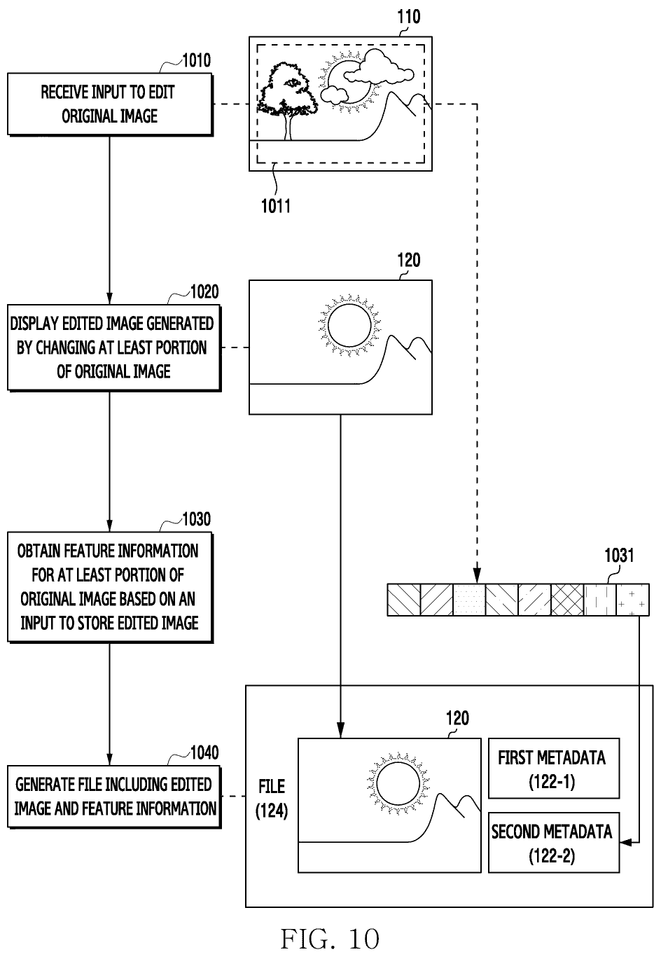

FIG. 10 is a diagram illustrating an example operation of an electronic device that generates a file 124 including feature information 1031 to be used to restore an original image 110 according to various embodiments. The electronic device 101 of FIG. 1, FIG. 2A, and FIG. 2B and/or the processor 210 of FIG. 2A and/or FIG. 2B may perform an operation described with reference to FIG. 10. At least one of operations of FIG. 10 may be associated with the operations of FIG. 3, or may be performed similarly. An order of operations of FIG. 10 is an example, and in an embodiment, the electronic device may perform the operations of FIG. 10 in another order different from the order illustrated in FIG. 10. In an embodiment, the electronic device may perform at least two the operations of FIG. 10 substantially simultaneously.

Referring to FIG. 10, in operation 1010, a processor of the electronic device according to an embodiment may receive an input to edit the original image 110. Within a state (e.g., the states 191, 192, and 193 of FIG. 1 and/or the states 502, 503, and 504 of FIG. 5) of displaying the original image 110 on a display (e.g., the display 130 of FIG. 1), the processor may receive an input of the operation 1010. The input of the operation 1010 may include the input of the operation 310 of FIG. 3, the input of the operation 710 of FIG. 7, the input of the operation 810 of FIG. 8, and/or the input of the operation 910 of FIG. 9. Referring to FIG. 10, in a state of displaying the original image 110 associated with a landscape including a tree, a cloud, the sun, and a mountain, it is assumed that the processor receives an input indicating removal of the tree and/or the cloud.

Referring to FIG. 10, in operation 1020, the processor of the electronic device according to an embodiment may display an edited image 120 generated by changing at least a portion (e.g., a portion 1011) of the original image 110. The processor may obtain the edited image 120 by performing the operations 320 and 330 of FIG. 3, the operation 720 of FIG. 7, the operation 820, and/or the operation 920 of FIG. 9. For example, the processor may obtain the edited image 120 by executing an image editing model (e.g., the image editing model 230 of FIG. 2A and/or FIG. 2B) using information associated with the input of the operation 1010.

Referring to FIG. 10, in operation 1030, the processor of the electronic device according to an embodiment may obtain the feature information 1031 for at least a portion (e.g., the portion 1011) of the original image 110 based on an input to store the edited image 120. Based on receiving an input indicating storage of the edited image 120, the processor may generate or obtain the feature information 1031 associated with at least a portion of the original image 110. At least a portion of the original image 110 may correspond to at least a portion of the edited image 120 to be replaced to restore the original image 110.

In an example case of FIG. 10, the processor may obtain the feature information 1031 associated with the portion 1011 of the original image 110 different from the edited image 120. The feature information 1031 may include a latent vector 624 output from the encoding model 621 of FIG. 6B to which the original image 110 (or the portion 1011) is input. Since the latent vector 624 is generated based on a dimension reduction, the processor may obtain the feature information 1031 of a relatively small size. For example, the feature information 1031 may include data output from a encoding part of an artificial intelligence model provided for an original reconstruction model, such as the encoding model 621 of FIG. 6B. Training of the artificial intelligence model may be performed based on an input indicating storage of the edited image 120. The training of the artificial intelligence model may be performed, using the edited image 120 and the original image 110 corresponding to the edited image 120. For example, based on the input of the operation 1030, the artificial intelligence model provided for the original reconstruction model may be trained using the original image 110 and the edited image 120.

Referring to FIG. 10, in operation 1040, the processor of the electronic device according to an embodiment may generate the file 124 including the edited image 120 and the feature information 1031. The processor may generate or store the file 124 including first metadata 122-1 including a change history changed from the original image 110 to the edited image 120 and information (e.g., the feature information 1031) to be used to restore the original image 110. The file 124 may include only the edited image 120 among the original image 110 and the edited image 120.

As described above, the file 124 stored by the processor performing an operation of FIG. 10 may include the feature information 1031 of a relatively small size, and may support restoration of the original image 110 using the feature information 1031. For example, when executing a restoration function of the original image 110, the feature information 1031 included in second metadata 122-2 of the file 124 may be input into the decoding model 622 of FIG. 6B. The electronic device may generate or display a restored image including content indicated by the feature information 1031, by performing calculations indicated by the decoding model 622 to which the feature information 1031 is input.

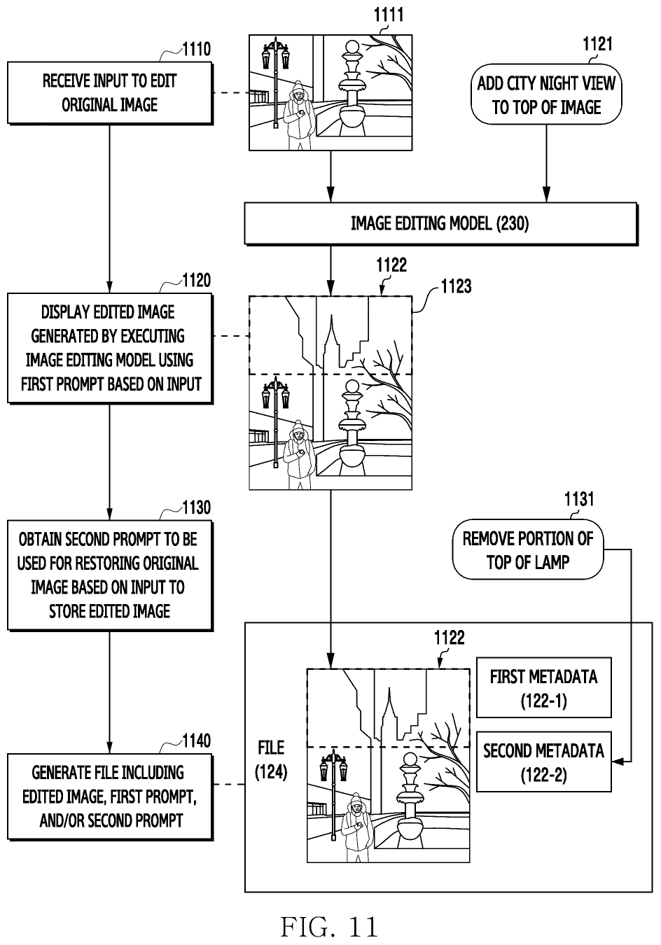

FIG. 11 is a diagram illustrating an example operation of an electronic device that generates a file including one or more prompts to be used to restore an original image according to various embodiments. The electronic device 101 of FIG. 1, FIG. 2A, and FIG. 2B and/or the processor 210 of FIG. 2A and/or FIG. 2B may perform an operation described with reference to FIG. 11. At least one of operations of FIG. 11 may be associated with the operations of FIG. 3, or may be performed similarly. An order of operations of FIG. 11 is an example, and in an embodiment, the electronic device may perform the operations of FIG. 11 in another order different from the order illustrated in FIG. 11. In an embodiment, the electronic device may perform at least two the operations of FIG. 11 substantially simultaneously.

Referring to FIG. 11, in operation 1110, a processor of the electronic device according to an embodiment may receive an input to edit an original image 1111. The processor may display an edit screen associated with the original image 1111 on a display (e.g., the display 130 of FIG. 1). While displaying the edit screen, the processor may receive an input of the operation 1110. The input of operation 1110 may include the input of the operation 310 of FIG. 3, the input of the operation 710 of FIG. 7, the input of the operation 810 of FIG. 8, the input of the operation 910 of FIG. 9, and/or the input of the operation 1010 of FIG. 10. The input of the operation 1110 may be received through a UI displayed by the electronic device 101. Referring to FIG. 11, in a state of displaying the original image 1111 expressing a night view including a person and a streetlight, it is assumed that the processor receives an input to add content to the original image 1111. For example, the electronic device 101 may provide an option for enlarging (e.g., expanding an area for out painting) a size of the original image 1111, within an edit screen. In response to an input associated with the option, the electronic device 101 may detect the input of the operation 1110 and generate a prompt 1121 associated with the input.

Referring to FIG. 11, within an operation 1120, the processor of the electronic device according to an embodiment may display an edited image 1122 generated by executing an image editing model 230 using a first prompt 1121 based on an input. The operation 1120 may be performed similarly to the operations 320 and 330 of FIG. 3, the operation 720 of FIG. 7, the operation 820 of FIG. 8, the operation 920 of FIG. 9, and/or the operation 1020 of FIG. 10. For example, the processor receiving the input of the operation 1110 may obtain or generate the first prompt 1121 associated with the input. For example, the processor may generate the first prompt 1121, using a visual object selected by the input. For example, the processor may detect the first prompt 1121 included in a text input (e.g., a software keyboard and/or a virtual keyboard) received from a user. For example, the processor may identify or detect the first prompt 1121 indicated by an audio signal, based on a STT. The processor may obtain or generate the edited image 1122, by performing calculations indicated by the image editing model 230 using the original image 1111 and/or the first prompt 1121.

In an example case of FIG. 11, the processor may obtain the edited image 1122 having a size larger than that of the original image 1111, from the image editing model 230 executed using the first prompt 1121. The edited image 1122 may have a shape further including content (e.g., content expressing a night view of a city) at a top of the original image 1111. For example, the edited image 1122 may further include a portion 1123 with respect to the original image 1111.

Referring to FIG. 11, in operation 1130, the processor of the electronic device according to an embodiment may obtain a second prompt 1131 to be used for restoring the original image 1111, based on an input to store the edited image 1122. For example, the processor may generate or obtain the second prompt 1131 to be used for restoring the original image 1111 from the first prompt 1121, by executing an artificial intelligence model for natural language processing. For example, the processor may obtain the second prompt 1122 indicating a different edit action (e.g., an action to remove added content) that is opposite to an edit action (e.g., an action to add the content to the original image 1111) indicated by the first prompt 1121.

In an example case of FIG. 11, the processor may generate a second prompt (e.g., “Remove a top portion of a lamp”, “Remove a rectangular area with a height of 500-pixels at a top of an image”) having a meaning opposite to a first prompt (e.g., “Add a city night view to a top of an image”, “Perform out-painting on a rectangular expanded area with a height of 500-pixels at a top of an image”) for adding content to the original image 1111. For example, the second prompt may include a word having a meaning opposite to the first prompt. For example, the second prompt may have an intention opposite to the first prompt. For example, an artificial intelligence model that outputs the second prompt 1131 from the first prompt 1121 may be trained to generate a prompt having a meaning and/or an intention opposite to the meaning and/or the intention of the prompt input to the artificial intelligence model.

Referring to FIG. 11, within an operation 1140, the processor of the electronic device according to an embodiment may generate a file 124 including the edited image 1122, the first prompt 1121, and/or the second prompt 1131. The processor may store the first prompt 1121 in the first metadata 122-1 of the file 124 as history information used to generate the edited image 1122. The processor may store the second prompt 1131 in the second metadata 122-2 of the file 124 as information for an artificial intelligence model to be executed to restore the original image 1111. For example, the processor may generate the file 124 including all of the edited image 1122, the first prompt 1121, and the second prompt 1131. The disclosure is not limited thereto.

Although an example operation of the electronic device generating the file 124 including the second prompt 1131 indicating removal of the portion 1123 of the edited image 1122 is described, the disclosure is not limited thereto. For example, in an embodiment in which an edited image is generated using a third prompt indicating addition of a specific subject, a fourth prompt indicating an edit action (e.g., removal of the specific subject) different from the third prompt may be stored in a file, together with the third prompt. In the example, when restoring the original image, the processor may change or remove a portion associated with the specific subject in the edited image, by executing an image restoration model using the fourth prompt.

As described above, in order to have a relatively small size, the file 124 generated by the processor performing the operation of FIG. 11 may include the second prompt 1131 to be provided to an artificial intelligence model to be executed using the edited image 1122, and may not include the original image 1111. When restoring the original image 1111, the electronic device may generate a restored image, which is the edited image 1122 to which an edit action associated with the second prompt 1131 is applied, by executing an image restoration model using the second prompt 1131 of the second metadata 122-2 and/or the edited image 1122 in the file 124. The electronic device may provide or display a generated restored image as a result of restoring the original image 1111.

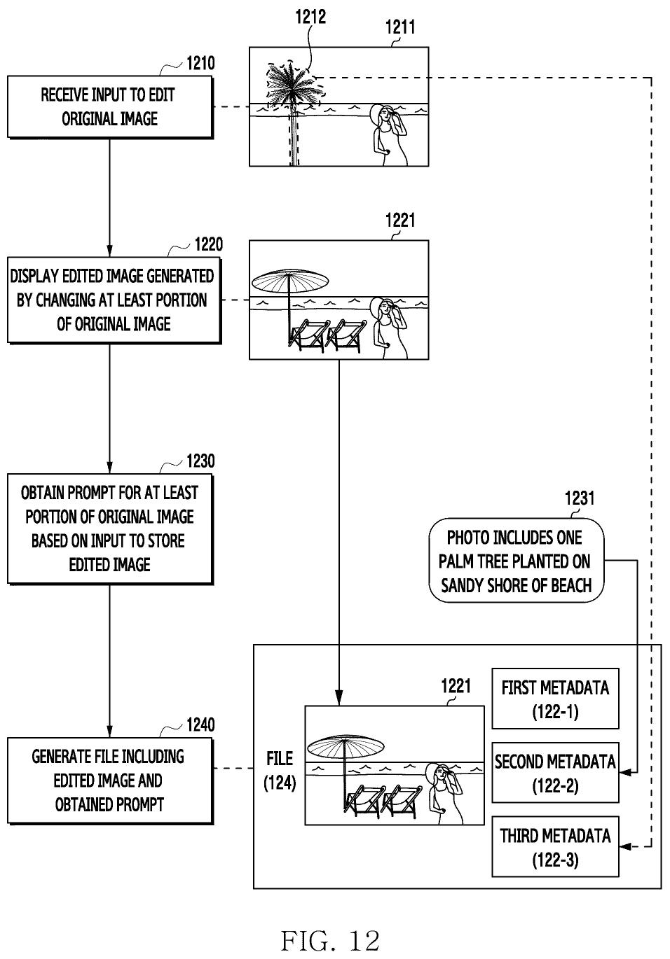

FIG. 12 is a diagram illustrating an example operation of an electronic device that generates a file 124 including one or more prompts 1231 for at least a portion of an original image 1211 different from an edited image 1221 according to various embodiments. The electronic device 101 of FIG. 1, FIG. 2A, and FIG. 2B and/or the processor 210 of FIG. 2A and/or FIG. 2B may perform an operation described with reference to FIG. 12. At least one of operations of FIG. 12 may be associated with the operations of FIG. 3, or may be performed similarly. An order of operations of FIG. 12 is an example, and in an embodiment, the electronic device may perform the operations of FIG. 12 in another order different from the order illustrated in FIG. 12. In an embodiment, the electronic device may perform at least two the operations of FIG. 12 substantially simultaneously.

Referring to FIG. 12, in operation 1210, a processor of the electronic device according to an embodiment may receive an input to edit the original image 1211. While displaying an edit screen, based on a touch gesture on a display (e.g., the display 130 of FIG. 1), the processor may detect or receive an input of the operation 1210. The processor may identify the input of the operation 1210, by analyzing an audio signal received through a microphone. The input of operation 1210 may include the input of the operation 310 of FIG. 3, the input of the operation 710 of FIG. 7, the input of the operation 810 of FIG. 8, the input of the operation 910 of FIG. 9, the input of the operation 1010 of FIG. 10, and/or the input of the operation 1110 of FIG. 11. Referring to FIG. 12, in a state of displaying the original image 1211 including a person, a beach, and a palm tree, it is assumed that the processor receives an input to change a specific subject (e.g., the palm tree) to another subject (e.g., a parasol and a plurality of chairs).

Referring to FIG. 12, in operation 1220, the processor of the electronic device according to an embodiment may display the edited image 1221 generated by changing at least a portion (e.g., a portion associated with the palm tree) of the original image 1211. The operation 1220 may be performed similarly to the operations 320 and 330 of FIG. 3, the operation 720 of FIG. 7, the operation 820 of FIG. 8, the operation 920 of FIG. 9, the operation 1020 of FIG. 10, and/or the operation 1120 of FIG. 11. For example, the processor may generate a prompt associated with the input of operation 1210. The processor may obtain or generate the edited image 1221, by performing calculations indicated by an image editing model (e.g., the image editing model 230 of FIG. 2A and/or FIG. 2B) using a generated prompt. The processor may display the obtained edited image 1221 on the display.

Referring to FIG. 12, in operation 1230, the processor of the electronic device according to an embodiment may obtain a prompt 1231 for at least a portion (a portion associated with the palm tree) of the original image 1211, based on an input to store the edited image 1221. The prompt 1231 obtained based on the operation 1230 may include a natural language sentence (e.g., for natural numbers x, y, “a photo includes a single straight-trunked palm tree with a width of 300 pixels×a height of 700 pixels, planted on a sandy shore of a beach centered at a coordinate location (x, y).”) describing at least a portion (e.g., a portion of the original image 1211 different from the edited image 1221) of the original image 1211 before being changed to the edited image 1221. The prompt 1231 may be generated by executing an artificial intelligence model trained to output one or more natural language sentences indicating a feature of an input image, from the input image.

For example, the prompt 1231 may include one or more words indicating a type and a shape of one or more subjects (e.g., the palm tree) associated with the original image 1211 before being changed to the edited image 1221, and/or a location (e.g., a location of a portion associated with a subject) within the original image 1211. For example, the processor may generate or obtain the prompt 1231 describing at least a portion of the original image 1211. For example, the prompt 1231 may be a natural language sentence (e.g., “a photo includes a palm tree planted on a sandy shore of a beach”) describing at least a portion of the original image 1211 that is different from the edited image 1221. For example, the prompt 1231 may include one or more words indicating a type and a shape of one or more subjects associated with the original image 1211 before being changed to the edited image 1221, and/or a location within the original image 1211.

Referring to FIG. 12, in operation 1240, the processor of the electronic device according to an embodiment may generate the file 124 including the edited image 1221 and the obtained prompt 1231. The processor may generate the edited image 1221, first metadata 122-1 including history information of generating the edited image 1221 from the original image 1211, second metadata 122-2 including the prompt 1231 of the operation 1230, and third metadata 122-3 indicating a boundary line 1212 of a portion of the original image 1211 different from the edited image 1221. The third metadata 122-3 may include an image (e.g., an edge image) expressing the boundary line 1212.

In an embodiment, the processor may generate or store the file 124 including a result of recognizing one or more subjects associated with the original image 1211. The result may include data (e.g., data for forming bounding boxes) indicating portions of the original image 1211 associated with the one or more subjects. The result may include an identifier (e.g., an ID and/or a key value) uniquely assigned to the one or more subjects and the data matched to the identifier.

In an embodiment, the processor may store or insert, within the third metadata 122-3, data (e.g., edge images) expressing the boundary line 1212 of a portion of the original image 1211 different from the edited image 1221. The third metadata 122-3 may be stored in the file 124 to guide a portion of the edited image 1221 to be replaced by the prompt 1231 of the second metadata 122-2. Information indicating the portion of the edited image 1221 stored in the third metadata 122-3 may be referred to as layout information for the portion.

In an embodiment, when generating a file of the operation 1240, the processor may train or update an artificial intelligence model (e.g., the image editing model 230 of FIG. 2A and FIG. 2B and/or an image restoration model 1431 of FIG. 14) associated with restoration of the original image 1121, using information (e.g., a keyword and/or a natural language sentence describing the original image 1121, an edge image, and/or layout information) associated with the original image 1121. The training may be performed such that the artificial intelligence model generates or outputs a prompt optimized for restoration of the original image 1121. For example, the prompt may be generated by a dedicated artificial intelligence model (e.g., a prompt inference model) for inferring or generating a prompt. For example, when an artificial intelligence model for changing and/or restoring the original image 1121 is trained, a prompt inference model may be trained together.

In an embodiment, the file of the operation 1240 may be generated based on a similarity between a restored image generated using a prompt obtained based on the operation 1230 and the original image 1211. For example, the processor may generate or obtain the restored image by executing an artificial intelligence model (e.g., the image restoration model 1431 of FIG. 14) using the prompt of operation 1230. The processor may calculate or determine the similarity between the restored image and the original image 1211. In response to a similarity being greater than (or greater than or equal to) a threshold similarity, the processor may perform the operation 1240 to generate a file including the prompt of the operation 1230. In response to a similarity being less than (or less than or equal to) the threshold similarity, the processor may re-perform the operation 1230, instead of performing the operation 1240, to re-obtain at least one prompt associated with the original image 1211. The processor may determine whether to perform the operation 1240 using a re-obtained prompt, by comparing a restored image generated using the re-obtained prompt and the original image 1211.

As described above, the file 124 supporting restoration to the original image 1211 while having a relatively small size may be generated by the processor that performs the operation of FIG. 12. Using the file 124 not including the original image 1211, the electronic device may generate or obtain a restored image, which includes an appearance and/or content of the original image, from the edited image 1221 included in the file 124, using the prompt 1231 of the second metadata 122-2 and the edge image of the third metadata 122-3.

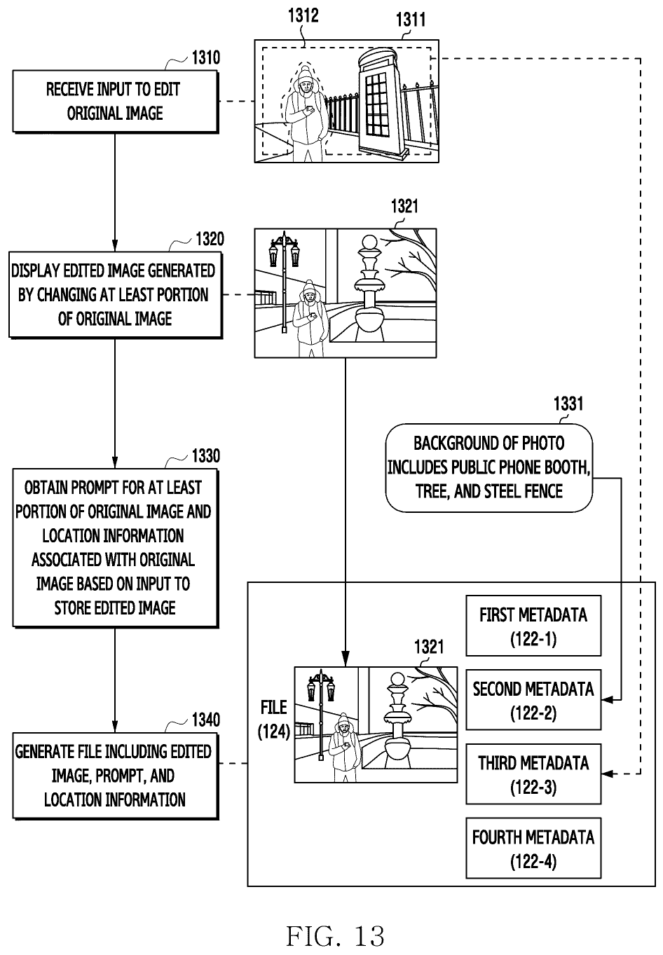

FIG. 13 is a diagram illustrating an example operation of an electronic device that generates a file 124 including one or more prompts (e.g., a prompt 1331) and location information associated with an original image 1311 according to various embodiments. The electronic device 101 of FIG. 1, FIG. 2A, and FIG. 2B and/or the processor 210 of FIG. 2A and/or FIG. 2B may perform an operation described with reference to FIG. 13. At least one of operations of FIG. 13 may be associated with the operations of FIG. 3, or may be performed similarly. An order of operations of FIG. 13 is an example, and in an embodiment, the electronic device may perform the operations of FIG. 13 in another order different from the order illustrated in FIG. 13. In an embodiment, the electronic device may perform at least two the operations of FIG. 13 substantially simultaneously.

Referring to FIG. 13, in operation 1310, a processor of the electronic device according to an embodiment may receive an input to edit the original image 1311. The input of the operation 1310 may indicate information (e.g., one or more prompts) to be used for execution of an image editing model (e.g., the image editing model 230 of FIG. 2A and/or FIG. 2B). The input of operation 1310 may include the input of the operation 310 of FIG. 3, the input of the operation 710 of FIG. 7, the input of the operation 810 of FIG. 8, the input of the operation 910 of FIG. 9, the input of the operation 1010 of FIG. 10, the input of the operation 1110 of FIG. 11, and/or the input of the operation 1210 of FIG. 12. Referring to FIG. 13, while displaying an edit screen including the original image 1311 expressing a landscape including a person, a phone booth, and a steel fence, it is assumed that the processor detects or receives the input of the operation 1310.

Referring to FIG. 13, in operation 1320, the processor of the electronic device according to an embodiment may display an edited image 1321 generated by changing at least a portion (e.g., a portion 1312) of the original image 1311. The operation 1320 may be performed similarly to the operations 320 and 330 of FIG. 3, the operation 720 of FIG. 7, the operation 820 of FIG. 8, the operation 920 of FIG. 9, the operation 1020 of FIG. 10, the operation 1120 of FIG. 12, and/or the operation 1220 of FIG. 12. For example, in case of receiving an input to change the portion 1312 corresponding to a background of the original image 1311, the processor may execute an image editing model using a prompt (e.g., “change a background of a photo to a night view of a city”) associated with the input. The processor may display, on the display, the edited image 1321 obtained by performing calculations indicated by the image editing model. Referring to FIG. 13, the edited image 1321 in which the portion 1312 corresponding to a background is changed from the original image 1311 may be displayed.

Referring to FIG. 13, in operation 1330, the processor of the electronic device according to an embodiment may obtain the prompt 1331 for at least a portion (e.g., the portion 1312) of the original image 1311 and location information associated with the original image 1311 based on an input to store the edited image 1321. The processor may obtain the prompt 1331 of the operation 1330, which is a natural language sentence describing the portion 1312 of the original image 1311 different from the edited image 1321. The prompt 1331 may include a natural language sentence (e.g., “a background of a photo includes a public phone booth, a tree, and a steel fence”) describing content of the portion 1312 of the original image 1311.

In an embodiment, together with information (e.g., the prompt 1331) associated with the original image 1311, the processor may obtain location information to be used by obtaining an additional image and/or video to be used for restoration of the original image 1311. For example, the location information may include a GPS coordinate for a point where the original image 1311 is captured. For example, when a function to restore the original image 1311 is executed, location information may be used to obtain information on an actual space associated with the original image 1311. Information on the actual space may include an image (e.g., a load view image and/or an image uploaded to a social network service (SNS)) uploaded to the Internet. The location information is not limited to the GPS coordinate, and may include an address (e.g., a uniform resource locator (URL) and/or a uniform resource indicator (URI)) in a network of information on the actual space. The address in a network may be linked to an image and/or a video, which is uploaded to the Internet, based on the actual space associated with the original image 1311.

Referring to FIG. 13, in operation 1340, the processor of the electronic device according to an embodiment may generate the file 124 including the edited image 1321, the prompt 1331, and location information. The processor performing the operation 1340 may search for or obtain an image similar to the original image 1311 among images uploaded to the Internet, using the location information of the operation 1330. The processor may store an address (e.g., URL and/or URI) in a network indicating a searched image in metadata of the file 124. The file 124 may include the edited image 1321 among the original image 1311 or the edited image 1321. For example, the file 124 may include first metadata 122-1 including history information during which the edited image 1321 is generated by changing the original image 1311. For example, the file 124 may include second metadata 122-2 including the prompt 1331 to be input into an artificial intelligence model (e.g., an image restoration model) for restoring the original image 1311. For example, the file 124 may include third metadata 122-3 including information indicating a boundary line between the edited image 1321 and a different portion 1312. For example, the file 124 may include fourth metadata 122-3 including the operation 1330.

As described above, the file 124 generated based on the operation 1340 of FIG. 13 may include the edited image 1321 and information for restoring the original image 1311 corresponding to the edited image 1321. When a function for restoring the original image 1311 using the file 124 is executed, the electronic device may execute an image restoration model using the prompt 1331 of the second metadata 122-2. For example, at least one of the edited image 1321, information (e.g., information associated with the portion 1312) included in the third metadata 122-3, or location information included in the fourth metadata 122-4 may be input into the image restoration model. For example, an image (e.g., a photo of an appearance of the actual space) and/or a video crawled (or searched) from the Internet based on the location information may be input into the image restoration model.

Hereinafter, an example operation of an electronic device that restores the original image 1311 using the file 124 generated based on the operation of FIG. 1 to FIG. 13 will be described in greater detail with reference to FIG. 14.

FIG. 14 is a diagram illustrating an example operation of an electronic device for restoring an original image 110 according to various embodiments. The electronic device 101 of FIG. 1, FIG. 2A, and FIG. 2B and/or the processor 210 of FIG. 2A and/or FIG. 2B may perform an operation described with reference to FIG. 14. An order of operations of FIG. 14 is an example, and in an embodiment, the electronic device may perform the operations of FIG. 14 in another order different from the order illustrated in FIG. 14. In an embodiment, the electronic device may perform at least two the operations of FIG. 14 substantially simultaneously.

Referring to FIG. 14, in operation 1410, a processor of the electronic device according to an embodiment may display an edited image 120 corresponding to the original image 110. The processor may display the edited image 120 identified from a file 124 on a display (e.g., the display 130 of FIG. 1). For example, in order to display a viewer screen including the edited image 120, the processor may control the display. The processor may determine whether the original image 110 may be restored, using metadata (e.g., the first metadata 122-1 to the fourth metadata 122-4 described with reference to FIG. 1 to FIG. 13) stored in the file 124. In case that the original image 110 corresponding to the edited image 120 may be restored, the processor may display, on the display, a visual object for restoring the original image 110.

Referring to FIG. 14, in operation 1420, the processor of the electronic device according to an embodiment may receive an input to at least partially restore the original image 110. The input may include an input indicating selection of a visual object displayed by the processor performing the operation 1410. Based on the input, the processor may perform an operation 1430.

Referring to FIG. 14, in operation 1430, the processor of the electronic device according to an embodiment may obtain metadata for at least partially restoring the original image 110 from the file 124 including the edited image 120. Metadata of the operation 1430 may include at least one of the first metadata 122-1 to the fourth metadata 122-4 described with reference to FIG. 1 to FIG. 13. The metadata of the operation 1430 may include information associated with the original image 110 (or content of the original image 110), such as information in Table 1.

Referring to FIG. 14, in operation 1440, the processor of the electronic device according to an embodiment may generate at least a portion of a restored image 150, by executing an image restoration model 1431 using obtained metadata. The image restoration model 1431 of FIG. 14 may have a structure of the generative artificial intelligence model of FIG. 6A to FIG. 6F. The processor may execute the image restoration model 1431 using the metadata and/or the edited image 120 in the operation 1430. In an embodiment in which the image restoration model 1431 is installed in the electronic device, the processor may generate at least a portion of the restored image 150 of the operation 1440, by directly performing calculations indicated by the image restoration model 1431. In an embodiment in which the image restoration model 1431 is installed in an external electronic device (e.g., the external electronic device 250 of FIG. 2B) different from the electronic device, the processor may receive or obtain at least a portion of the restored image 150 from the external electronic device by communicating with the external electronic device. For example, the processor may identify (e.g., a type, a structure, and a name of the image restoration model 1431 and/or location information of the image restoration model 1431) the image restoration model 1431 to be used for generating the restored image 150, using the metadata of the file 124. The processor may request an external electronic device to generate the restored image 150 using the identified image restoration model 1431.

Referring to FIG. 14, in operation 1450, the processor of the electronic device according to an embodiment may display at least a portion of the restored image 150. For example, the processor may display at least a portion of the restored image 150, by replacing the edited image 120 displayed on the display. The restored image 150 may include content and/or an appearance of the original image 110.

As described above, according to an embodiment, the electronic device may store reduced size information associated with the original image 110, in the file 124 including only the edited image 120 without the original image 110 (e.g., in metadata). Using the reduced size information, the file 124 may support restoration to the original image 110 while having a relatively small size.

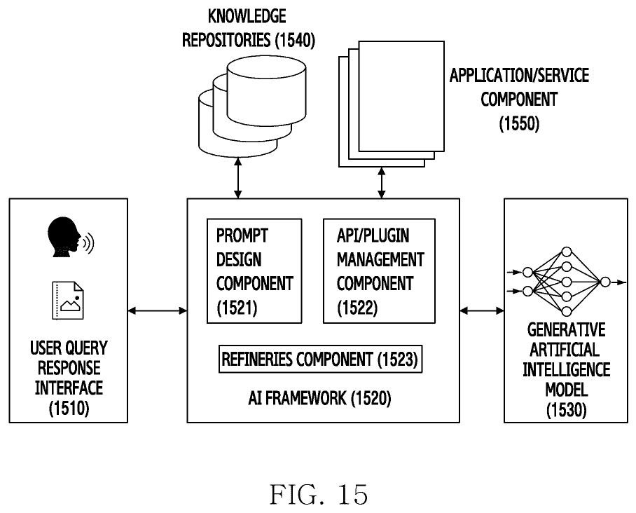

FIG. 15 is a diagram illustrating example programs executed by an electronic device to simulate a generative artificial intelligence model 1530 according to various embodiments. Referring to FIG. 15, a generative artificial intelligence system is illustrated. According to an embodiment, a processor (e.g., the processor 210 of FIG. 2A and/or FIG. 2B) of the electronic device (e.g., the electronic device 101 of FIG. 1) may execute a function associated with the generative artificial intelligence model 1530, by executing one or more programs divided by blocks of FIG. 15.

A user query response interface 1510 executed by the electronic device according to an embodiment may be executed by the electronic device to receive a user input. The input may include a non-verbal gesture (e.g., a touch input on a display of the electronic device), natural language sentences such as a prompt, an image, a video, or a combination thereof. The electronic device executing the user query response interface 1510 may obtain context information at a timing of receiving the input. The context information, which may include various information at the timing, may include, for example, a state of a program (or a software application) executed by the electronic device. The context information may include, for example, location information of the electronic device and/or a user.

The electronic device executing the user query response interface 1510 may output information generated by the generative artificial intelligence model 1530 in response to the input. The information may be output in a form of a natural language sentence. The information may be output in a form of a UI displayed on the display. Information generated by the generative artificial intelligence model 1530 may be output in a format selected by a user.

An AI framework 1520 may be a program for executing or controlling a component (e.g., a prompt design component 1521, an application programming interface (API)/plugin management component 1522, and/or a refinery component 1523) based on an input received through the user query response interface 1510. An input detected by executing the user query response interface 1510 may be processed by the prompt design component 1521. The electronic device executing the prompt design component 1521 may generate one or more prompts to be input to the generative artificial intelligence model 1530, such as a large language model (LLM), from the input. The prompt design component 1521 may include an artificial intelligence model capable of being trained to generate an improved prompt.

The electronic device executing the prompt design component 1521 may obtain information for generating the prompt, by accessing knowledge repositories 1540. The information for generating a prompt may include data on a preference of a user of the electronic device, a prompt library, and/or example prompts. One or more prompts generated based on execution of the prompt design component 1521 may be used for execution of the generative artificial intelligence model 1530.

The electronic device executing the API/plugin management component 1522 may execute a function for obtaining information additionally required for execution of the generative artificial intelligence model 1530 when executing the generative artificial intelligence model 1530 based on a user input. An API provided by the API/plugin management component 1522 may be used to establish a communication link (e.g., a channel and/or a session) between the generative artificial intelligence model 1530 and another software application. Through the communication link, information additionally required for execution of the generative artificial intelligence model 1530 may be provided to the generative artificial intelligence model 1530.

The electronic device executing the API/plug-in management component 1522 may trigger an action to be performed in an application/service component 1550 (e.g., a program and/or a software application installed in the electronic device) using an API provided by the API/plugin management component 1522. Information obtained by executing the application/service component 1550 may be used to generate a prompt based on execution of the prompt design component 1521, and/or may be input to the generative artificial intelligence model 1530.

The refinery component 1523 (or an output modification component) may change, modulate, or tune output data of the generative artificial intelligence model 1530. The electronic device executing the refinery component 1523 may detect relevance, bias, appropriateness, or a hallucination of the output data of the generative artificial intelligence model 1530. The electronic device executing the refineries component 1523 may determine whether to re-execute the generative artificial intelligence model 1530, based on the detected relevance, bias, appropriateness, and/or hallucination. The electronic device executing the refineries component 1523 may display hints (e.g., an image and/or text) to reduce or prevent unintended output data to a user.

The generated artificial intelligence model 1530 may refer, for example, to an artificial intelligence model that generates new information and/or data, based on a user input. The generative artificial intelligence model 1530 may include an artificial intelligence model that generates an image and/or a natural language. The artificial intelligence model that generates an image may include a diffusion model based on a generative adversarial network (GAN), a variational auto encoder (VAE), and/or a transformer. The artificial intelligence model that generates natural language, which may include a model trained to output statistically appropriate natural language, may include CHAT-GPT 3 and/or CHAT-GPT 4. The disclosure is not limited thereto, and the generative artificial intelligence model 1530 may include a large multimodal model (LMM) that receives various types of input data including text, an image, and/or an audio signal and then generates output data associated with the input data.

FIG. 16 is a block diagram illustrating an example electronic device 1601 in a network environment 1600 according to various embodiments. Referring to FIG. 16, the electronic device 1601 in the network environment 1600 may communicate with an electronic device 1602 via a first network 1698 (e.g., a short-range wireless communication network), or at least one of an electronic device 1604 or a server 1608 via a second network 1699 (e.g., a long-range wireless communication network). According to an embodiment, the electronic device 1601 may communicate with the electronic device 1604 via the server 1608. According to an embodiment, the electronic device 1601 may include a processor 1620, memory 1630, an input module 1650, a sound output module 1655, a display module 1660, an audio module 1670, a sensor module 1676, an interface 1677, a connecting terminal 1678, a haptic module 1679, a camera module 1680, a power management module 1688, a battery 1689, a communication module 1690, a subscriber identification module (SIM) 1696, or an antenna module 1697. In various embodiments, at least one of the components (e.g., the connecting terminal 1678) may be omitted from the electronic device 1601, or one or more other components may be added in the electronic device 1601. In various embodiments, some of the components (e.g., the sensor module 1676, the camera module 1680, or the antenna module 1697) may be implemented as a single component (e.g., the display module 1660).

The processor 1620 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. The processor 1620 may execute, for example, software (e.g., a program 1640) to control at least one other component (e.g., a hardware or software component) of the electronic device 1601 coupled with the processor 1620, and may perform various data processing or computation. According to an embodiment, as at least part of the data processing or computation, the processor 1620 may store a command or data received from another component (e.g., the sensor module 1676 or the communication module 1690) in volatile memory 1632, process the command or the data stored in the volatile memory 1632, and store resulting data in non-volatile memory 1634. According to an embodiment, the processor 1620 may include a main processor 1621 (e.g., a central processing unit (CPU) or an application processor (AP)), or an auxiliary processor 1623 (e.g., a graphics processing unit (GPU), a neural processing unit (NPU), an image signal processor (ISP), a sensor hub processor, or a communication processor (CP)) that is operable independently from, or in conjunction with, the main processor 1621. For example, when the electronic device 1601 includes the main processor 1621 and the auxiliary processor 1623, the auxiliary processor 1623 may be adapted to consume less power than the main processor 1621, or to be specific to a specified function. The auxiliary processor 1623 may be implemented as separate from, or as part of the main processor 1621.

The auxiliary processor 1623 may control at least some of functions or states related to at least one component (e.g., the display module 1660, the sensor module 1676, or the communication module 1690) among the components of the electronic device 1601, instead of the main processor 1621 while the main processor 1621 is in an inactive (e.g., sleep) state, or together with the main processor 1621 while the main processor 1621 is in an active state (e.g., executing an application). According to an embodiment, the auxiliary processor 1623 (e.g., an image signal processor or a communication processor) may be implemented as part of another component (e.g., the camera module 1680 or the communication module 1690) functionally related to the auxiliary processor 1623. According to an embodiment, the auxiliary processor 1623 (e.g., the neural processing unit) may include a hardware structure specified for artificial intelligence model processing. An artificial intelligence model may be generated by machine learning. Such learning may be performed, e.g., by the electronic device 1601 where the artificial intelligence is performed or via a separate server (e.g., the server 1608). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 1630 may store various data used by at least one component (e.g., the processor 1620 or the sensor module 1676) of the electronic device 1601. The various data may include, for example, software (e.g., the program 1640) and input data or output data for a command related thereto. The memory 1630 may include the volatile memory 1632 or the non-volatile memory 1634.

The program 1640 may be stored in the memory 1630 as software, and may include, for example, an operating system (OS) 1642, middleware 1644, or an application 1646.

The input module 1650 may receive a command or data to be used by another component (e.g., the processor 1620) of the electronic device 1601, from the outside (e.g., a user) of the electronic device 1601. The input module 1650 may include, for example, a microphone, a mouse, a keyboard, a key (e.g., a button), or a digital pen (e.g., a stylus pen).

The sound output module 1655 may output sound signals to the outside of the electronic device 1601. The sound output module 1655 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 1660 may visually provide information to the outside (e.g., a user) of the electronic device 1601. The display module 1660 may include, for example, a display, a hologram device, or a projector and control circuitry to control a corresponding one of the display, hologram device, and projector. According to an embodiment, the display module 1660 may include a touch sensor adapted to detect a touch, or a pressure sensor adapted to measure the intensity of force incurred by the touch.

The audio module 1670 may convert a sound into an electrical signal and vice versa. According to an embodiment, the audio module 1670 may obtain the sound via the input module 1650, or output the sound via the sound output module 1655 or a headphone of an external electronic device (e.g., an electronic device 1602) directly (e.g., wiredly) or wirelessly coupled with the electronic device 1601.

The sensor module 1676 may detect an operational state (e.g., power or temperature) of the electronic device 1601 or an environmental state (e.g., a state of a user) external to the electronic device 1601, and then generate an electrical signal or data value corresponding to the detected state. According to an embodiment, the sensor module 1676 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1677 may support one or more specified protocols to be used for the electronic device 1601 to be coupled with the external electronic device (e.g., the electronic device 1602) directly (e.g., wiredly) or wirelessly. According to an embodiment, the interface 1677 may include, for example, a high definition multimedia interface (HDMI), a universal serial bus (USB) interface, a secure digital (SD) card interface, or an audio interface.

A connecting terminal 1678 may include a connector via which the electronic device 1601 may be physically connected with the external electronic device (e.g., the electronic device 1602). According to an embodiment, the connecting terminal 1678 may include, for example, an HDMI connector, a USB connector, a SD card connector, or an audio connector (e.g., a headphone connector).

The haptic module 1679 may convert an electrical signal into a mechanical stimulus (e.g., a vibration or a movement) or electrical stimulus which may be recognized by a user via his tactile sensation or kinesthetic sensation. According to an embodiment, the haptic module 1679 may include, for example, a motor, a piezoelectric element, or an electric stimulator.

The camera module 1680 may capture a still image or moving images. According to an embodiment, the camera module 1680 may include one or more lenses, image sensors, image signal processors, or flashes.

The power management module 1688 may manage power supplied to the electronic device 1601. According to an embodiment, the power management module 1688 may be implemented as at least part of, for example, a power management integrated circuit (PMIC).

The battery 1689 may supply power to at least one component of the electronic device 1601. According to an embodiment, the battery 1689 may include, for example, a primary cell which is not rechargeable, a secondary cell which is rechargeable, or a fuel cell.

The communication module 1690 may support establishing a direct (e.g., wircd) communication channel or a wireless communication channel between the electronic device 1601 and the external electronic device (e.g., the electronic device 1602, the electronic device 1604, or the server 1608) and performing communication via the established communication channel. The communication module 1690 may include one or more communication processors that are operable independently from the processor 1620 (e.g., the application processor (AP)) and supports a direct (e.g., wired) communication or a wireless communication. According to an embodiment, the communication module 1690 may include a wireless communication module 1692 (e.g., a cellular communication module, a short-range wireless communication module, or a global navigation satellite system (GNSS) communication module) or a wired communication module 1694 (e.g., a local area network (LAN) communication module or a power line communication (PLC) module). A corresponding one of these communication modules may communicate with the external electronic device via the first network 1698 (e.g., a short-range communication network, such as Bluetooth™, wireless-fidelity (Wi-Fi) direct, or infrared data association (IrDA)) or the second network 1699 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 1692 may identify and authenticate the electronic device 1601 in a communication network, such as the first network 1698 or the second network 1699, using subscriber information (e.g., international mobile subscriber identity (IMSI)) stored in the subscriber identification module 1696.

The wireless communication module 1692 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 1692 may support a high-frequency band (e.g., the mm Wave band) to achieve, e.g., a high data transmission rate. The wireless communication module 1692 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 1692 may support various requirements specified in the electronic device 1601, an external electronic device (e.g., the electronic device 1604), or a network system (e.g., the second network 1699). According to an embodiment, the wireless communication module 1692 may support a peak data rate (e.g., 20 Gbps or more) for implementing eMBB, loss coverage (e.g., 1664 dB or less) for implementing mMTC, or U-plane latency (e.g., 0.5 ms or less for each of downlink (DL) and uplink (UL), or a round trip of 16 ms or less) for implementing URLLC.

The antenna module 1697 may transmit or receive a signal or power to or from the outside (e.g., the external electronic device) of the electronic device 1601. According to an embodiment, the antenna module 1697 may include an antenna including a radiating element including a conductive material or a conductive pattern formed in or on a substrate (e.g., a printed circuit board (PCB)). According to an embodiment, the antenna module 1697 may include a plurality of antennas (e.g., array antennas). In such a case, at least one antenna appropriate for a communication scheme used in the communication network, such as the first network 1698 or the second network 1699, may be selected, for example, by the communication module 1690 (e.g., the wireless communication module 1692) from the plurality of antennas. The signal or the power may then be transmitted or received between the communication module 1690 and the external electronic device via the selected at least one antenna. According to an embodiment, another component (e.g., a radio frequency integrated circuit (RFIC)) other than the radiating element may be additionally formed as part of the antenna module 1697.

According to various embodiments, the antenna module 1697 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1601 and the external electronic device 1604 via the server 1608 coupled with the second network 1699. Each of the electronic devices 1602 or 1604 may be a device of a same type as, or a different type, from the electronic device 1601. According to an embodiment, all or some of operations to be executed at the electronic device 1601 may be executed at one or more of the external electronic devices 1602, 1604, or 1608. For example, if the electronic device 1601 should perform a function or a service automatically, or in response to a request from a user or another device, the electronic device 1601, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1601. The electronic device 1601 may provide the outcome, with or without further processing of the outcome, as at least part of a reply to the request. To that end, a cloud computing, distributed computing, mobile edge computing (MEC), or client-server computing technology may be used, for example. The electronic device 1601 may provide ultra low-latency services using, e.g., distributed computing or mobile edge computing. In an embodiment, the external electronic device 1604 may include an internet-of-things (IoT) device. The server 1608 may be an intelligent server using machine learning and/or a neural network. According to an embodiment, the external electronic device 1604 or the server 1608 may be included in the second network 1699. The electronic device 1601 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), the element may be coupled with the other element directly (e.g., wiredly), wirelessly, or via a third element.

As used in connection with various embodiments of the disclosure, the term “module” may include a unit implemented in hardware, and may interchangeably be used with other terms, for example, “logic,” “block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 1640) including one or more instructions that are stored in a storage medium (e.g., internal memory 1636 or external memory 1638) that is readable by a machine (e.g., the electronic device 1601). For example, a processor (e.g., the processor 1620) of the machine (e.g., the electronic device 1601) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added. The electronic device 1601 of FIG. 16 may be an example of the electronic device 101 of FIG. 1, FIG. 2A and/or FIG. 2B.

In an embodiment, a method of storing an edited image of an original image together with information for restoring the original image may be required. In an embodiment, a method of generating information required to restore an original image using an artificial intelligence model may be required. As described above, according to an example embodiment, an electronic device (e.g., the electronic device 101 of FIG. 1 and/or the electronic device 1601 of FIG. 16) may comprise: a display (e.g., the display 130 of FIG. 1), at least one processor (e.g., the processor 210 of FIG. 2A and/or FIG. 2B) comprising processing circuitry, and memory (e.g., the memory 215 of FIG. 2A and/or FIG. 2B), comprising one or more storage mediums, storing instructions. At least one processor, individually and/or collectively, may be configured to: control the display to display, via the display, an image including at least one object. At least one processor, individually and/or collectively, may be configured to receive an input with respect to the at least one object. At least one processor, individually and/or collectively, may be configured to, based at least in part on the input, generate an artificial intelligence (AI) image using an AI model wherein the at least one object is replaced with an AI generated object. At least one processor, individually and/or collectively, may be configured to generate first information with respect to the input and second information with respect to the AI generated object. At least one processor, individually and/or collectively, may be configured to store, in the memory, a file including the AI image and metadata including the first information and the second information. According to an embodiment, the electronic device may store an edited image with respect to an original image, together with information to restore the original image. According to an embodiment, the electronic device may generate information required to restore an original image using an AI model.

For example, at least one processor, individually and/or collectively, may be configured to control the display to display the AI image as a replacement of the image. At least one processor, individually and/or collectively, may be configured to receive another input to store the AI image while displaying the AI image.

For example, at least one processor, individually and/or collectively, may be configured to generate the first information including a prompt corresponding to a natural language sentence describing the at least one object.

For example, at least one processor, individually and/or collectively, may be configured to obtain the second information including another prompt including a word having a meaning opposite to a word included in the prompt included in the first information.

For example, at least one processor, individually and/or collectively, may be configured to, as at least part of generating of the first information, generate the first information including feature information associated with the at least one object.

For example, at least one processor, individually and/or collectively, may be configured to, as at least part of generating of the first information, generate the first information including pixel information of the replaced at least one object.

For example, at least one processor, individually and/or collectively, may be configured to generate the first information including a prompt associated with the AI generated object.

For example, at least one processor, individually and/or collectively, may be configured to, as at least part of generating of the second information, generate the second information indicating a pixel difference between the image and the AI image.

As described above, according to an example embodiment, a non-transitory computer-readable storage medium comprising instructions may be provided. The instructions, when executed by at least one processor, individually and/or collectively, of an electronic device including a display, may cause the electronic device to display, via the display, an image including at least one object. The instructions, when executed by at least one processor, comprising processing circuitry, individually and/or collectively, of the electronic device, may cause the electronic device to receive an input with respect to the at least one object. The instructions, when executed by at least one processor, comprising processing circuitry, individually and/or collectively, of the electronic device, may cause the electronic device to, based at least in part on the input, generate an artificial intelligence (AI) image using an AI model wherein the at least one object is replaced with an AI generated object. The instructions, when executed by at least one processor, comprising processing circuitry, individually and/or collectively, of the electronic device, may cause the electronic device to generate first information with respect to the input and second information with respect to the AI generated object. The instructions, when executed by at least one processor, comprising processing circuitry, individually and/or collectively, of the electronic device, may cause the electronic device to store, in the memory, a file including the AI image and metadata including the first information and the second information.

For example, the instructions, when executed by at least one processor, comprising processing circuitry, individually and/or collectively, of the electronic device, may cause the electronic device to display the AI image as a replacement of the image. The instructions, when executed by at least one processor, comprising processing circuitry, individually and/or collectively, of the electronic device, may cause the electronic device to receive another input to store the AI image while displaying the AIO image.

For example, the instructions, when executed by at least one processor, comprising processing circuitry, individually and/or collectively, of the electronic device, may cause the electronic device to generate the first information including a prompt corresponding to a natural language sentence describing the at least one object.

For example, the instructions, when executed by at least one processor, comprising processing circuitry, individually and/or collectively, of the electronic device, may cause the electronic device to obtain the second information including another prompt including a word having a meaning opposite to a word included in the prompt included in the first information.

For example, the instructions, when executed by at least one processor, comprising processing circuitry, individually and/or collectively, of the electronic device, may cause the electronic device to, as at least part of generating of the first information, generate the first information including feature information associated with the at least one object.

For example, the instructions, when executed by at least one processor, comprising processing circuitry, individually and/or collectively, of the electronic device, may cause the electronic device to as at least part of generating of the first information, generate the first information including a pixel information of the replaced at least one object.

For example, the instructions, when executed by at least one processor, comprising processing circuitry, individually and/or collectively, of the electronic device, may cause the electronic device to generate the first information including a prompt associated with the AI generated object.

For example, the instructions, when executed by at least one processor, comprising processing circuitry, individually and/or collectively, of the electronic device, may cause the electronic device to, as at least part of generating of the second information, generate the second information indicating a pixel difference between an original image and an edited image.

According to an example embodiment, an electronic device (e.g., the electronic device 101 of FIG. 1 and/or the electronic device 1601 of FIG. 16) may comprise a display (e.g., the display 130 of FIG. 1), at least one processor (e.g., the processor 210 of FIG. 2A and/or FIG. 2B) comprising processing circuitry, and memory (e.g., the memory 215 of FIG. 2A and/or FIG. 2B), comprising one or more storage mediums, storing instructions. At least one processor individually or collectively, may be configured to execute the instructions and to cause the electronic device to display, on the display, an edit screen including an original image (e.g., the original image 110 of FIG. 1). At least one processor individually or collectively, may be configured to execute the instructions and to cause the electronic device to, based on receiving a first input to edit the original image, via the edit screen, execute an artificial intelligence model using the first information associated with the first input, and generate an edited image (e.g., the edited images 115 and 120 of FIG. 1) corresponding to the original image. At least one processor individually or collectively, may be configured to execute the instructions and to cause the electronic device to, in response to the first input, display the edited image on the edit screen. At least one processor individually or collectively, may be configured to execute the instructions and to cause the electronic device to, while displaying the edited image, based on receiving a second input to store the edited image, generate second information associated with the artificial intelligence model to be executed to restore the original image. At least one processor individually or collectively, may be configured to execute the instructions and to cause the electronic device to store metadata (e.g., the metadata 122 of FIG. 1) including the first information and the second information and a file (e.g., the file 124 of FIG. 1) including the edited image in the memory. According to an embodiment, the electronic device may store an edited image with respect to an original image, together with information to restore the original image. According to an embodiment, the electronic device may generate information required to restore an original image using an AI model.

For example, at least one processor individually or collectively, may be configured to cause the electronic device to generate the second information including a prompt (e.g., the data 932 of FIG. 9 and/or the prompt 1231 of FIG. 12) describing the original image.

For example, the prompt may include a natural language sentence describing at least part of the original image different from the edited image.

For example, at least one processor individually or collectively, may be configured to cause the electronic device to obtain the second information including a second prompt (e.g., the second prompt 1131 of FIG. 11) including a word having a meaning opposite to a word included in a first prompt (e.g., the first prompt 1121 of FIG. 11) included in the first information.

For example, at least one processor individually or collectively, may be configured to cause the electronic device to, based on receiving the second input, generate the second information including feature information (e.g., the feature information 1031 of FIG. 10) associated with at least part of the original image. The at least part of the original image (e.g., the portion 1011 of FIG. 10) may correspond to at least part of the edited image to be replaced in order to restore the original image.

For example, at least one processor individually or collectively, may be configured to cause the electronic device to: generate the second information including, in a state in which the edited image is generated by changing a portion of the original image, based on receiving the second input, pixel information (e.g., the pixel information 931 of FIG. 9) of a first area within the portion, distinguished by content of the portion of the original image, and a prompt (e.g., the data 932 of FIG. 9) associated with a second area in the portion different from the first area.

For example, at least one processor individually or collectively, may be configured to cause the electronic device to, based on receiving the second input, generate the second information indicating a pixel difference between the original image and the edited image.

For example, at least one processor individually or collectively, may be configured to cause the electronic device to, in a state in which the edited image is generated by changing a portion of the original image, based on receiving the second input, generate the second information indicating a color of pixels corresponding to the portion.

As described above, in an example embodiment, a non-transitory computer-readable storage medium comprising instructions may be provided. The instructions, when executed by at least one processor, comprising processing circuitry, individually and/or collectively, of an electronic device including a display, may cause the electronic device to display, on the display, an edit screen including an original image. The instructions, when executed by at least one processor, comprising processing circuitry, individually and/or collectively, of the electronic device including a display, may cause the electronic device to, based on receiving a first input to edit the original image, via the edit screen, execute an artificial intelligence model using the first information associated with the first input, and generate an edited image corresponding to the original image. The instructions, when executed by at least one processor, comprising processing circuitry, individually and/or collectively, of the electronic device including a display, may cause the electronic device to, in response to the first input, display the edited image on the edit screen. The instructions, when executed by at least one processor, comprising processing circuitry, individually and/or collectively, of the electronic device including a display, may cause the electronic device to, while displaying the edited image, based on receiving a second input to store the edited image, generate second information associated with the artificial intelligence model to be executed to restore the original image. The instructions, when executed by at least one processor, comprising processing circuitry, individually and/or collectively, of the electronic device including a display, may cause the electronic device to store metadata including the first information and the second information and a file including the edited image in the memory.

For example, the instructions, when executed by at least one processor, comprising processing circuitry, individually and/or collectively, of the electronic device including a display, may cause the electronic device to generate the second information including a prompt describing the original image.

For example, the prompt may include a natural language sentence describing at least part of the original image different from the edited image.

For example, the instructions, when executed by at least one processor, comprising processing circuitry, individually and/or collectively, of the electronic device including a display, may cause the electronic device to obtain the second information including a second prompt including a word having a meaning opposite to a word included in a first prompt included in the first information.

For example, the instructions, when executed by at least one processor, comprising processing circuitry, individually and/or collectively, of the electronic device including a display, may cause the electronic device to, based on receiving the second input, generate the second information including feature information associated with at least part of the original image. The at least part of the original image may correspond to at least part of the edited image to be replaced in order to restore the original image.

For example, the instructions, when executed by at least one processor, comprising processing circuitry, individually and/or collectively, of the electronic device including a display, may cause the electronic device to generate the second information including, in a state in which the edited image is generated by changing a portion of the original image, based on receiving the second input, pixel information of a first area within the portion, distinguished by content of the portion of the original image, and a prompt associated with a second area in the portion different from the first area.

For example, the instructions, when executed by at least one processor, comprising processing circuitry, individually and/or collectively, of the electronic device including a display, may cause the electronic device to, based on receiving the second input, generate the second information indicating a pixel difference between the original image and the edited image.

For example, the instructions, when executed by at least one processor, comprising processing circuitry, individually and/or collectively, of the electronic device including a display, may cause the electronic device to in a state in which the edited image is generated by changing a portion of the original image, based on receiving the second input, generate the second information indicating a color of pixels corresponding to the portion.

As described above, in an example embodiment, a method of an electronic device comprising a display may be provided. The method may include displaying, on the display, an edit screen including an original image. The method may include, based on receiving a first input to edit the original image, changing a first portion of the original image. The method may include, while displaying an edited image which is the original image of which the first portion is changed to a second portion, based on receiving a second input to store the edited image, storing a file including first metadata indicating the second portion, second metadata including information to restore content of the first portion of the original image different from the edited image using an artificial intelligence model, and the edited image from among the original image or the edited image.

For example, the changing may comprise obtaining the edited image where the first portion is changed by executing an artificial intelligence model using a first prompt indicated by the first input.

For example, the storing may comprise storing, in the first metadata, the first prompt. The storing may comprise storing, in the second metadata, a second prompt including a word having a meaning opposite to a word included in the first prompt.

For example, the storing may comprise storing, in the second metadata, at least one prompt describing the content of the first portion to be input to the artificial intelligence model.

For example, the storing may comprise storing, in the second metadata, feature information of the first portion of the original image.

As described above, according to an example embodiment, an electronic device (e.g., the electronic device 101 of FIG. 1 and/or the electronic device 1601 of FIG. 16) may comprise: a display (e.g., the display 130 of FIG. 1), at least one processor (e.g., the processor 210 of FIG. 2A and/or FIG. 2B) comprising processing circuitry, and memory (e.g., the memory 215 of FIG. 2B), comprising one or more storage mediums, storing instructions. At least one processor individually or collectively, may be configured to execute the instructions and to cause the electronic device to display, on the display, an edit screen including an original image (e.g., the original image 110 of FIG. 1). At least one processor individually or collectively, may be configured to execute the instructions and to cause the electronic device to, based on receiving a first input to edit the original image, change a first portion of the original image. At least one processor individually or collectively, may be configured to execute the instructions and to cause the electronic device to, while displaying an edited image (e.g., the edited images 115 and 120 of FIG. 1) which is the original image of which the first portion is changed to a second portion, based on receiving a second input to store the edited image, store a file (e.g., the file 124 of FIG. 1) including, first metadata (e.g., the first metadata 122-1 of FIGS. 7 to 13) indicating the second portion, second metadata (e.g., the second metadata 122-2 of FIGS. 7 to 13) including information to restore content of the first portion of the original image different from the edited image using an artificial intelligence model, and the edited image from among the original image or the edited image.

For example, at least one processor individually or collectively, may be configured to cause the electronic device to obtain the edited image where the first portion is changed by executing an artificial intelligence model using a first prompt indicated by the first input.

For example, at least one processor individually or collectively, may be configured to cause the electronic device to store, in the first metadata, the first prompt. At least one processor individually or collectively, may be configured to cause the electronic device to store, in the second metadata, a second prompt including a word having a meaning opposite to a word included in the first prompt.

For example, at least one processor individually or collectively, may be configured to cause the electronic device to store, in the second metadata, at least one prompt describing the content of the first portion to be input to the artificial intelligence model.

For example, at least one processor individually or collectively, may be configured to cause the electronic device to store, in the second metadata, feature information of the first portion of the original image.

As used herein, the term “if” is, optionally, understood as “when” or “upon” or “in response to determining” or “in response to detecting,” depending on the context. Similarly, the phrase “if it is determined” or “if [a stated condition or event] is detected” is, optionally, understood as “upon determining” or “in response to determining” or “upon detecting [the stated condition or event]” or “in response to detecting [the stated condition or event],” depending on the context.

The device described above may be implemented as a hardware component, a software component, and/or a combination of a hardware component and a software component. For example, the devices and components described in the various embodiments may be implemented using one or more general purpose computers or special purpose computers, such as a processor, controller, arithmetic logic unit (ALU), digital signal processor, microcomputer, field programmable gate array (FPGA), programmable logic unit (PLU), microprocessor, or any other device capable of executing and responding to instructions. The processing device may perform an operating system (OS) and one or more software applications executed on the operating system. In addition, the processing device may access, store, manipulate, process, and generate data in response to the execution of the software. For convenience of understanding, there is a case that one processing device is described as being used, but a person who has ordinary knowledge in the relevant technical field may see that the processing device may include a plurality of processing elements and/or a plurality of types of processing elements. For example, the processing device may include a plurality of processors or one processor and one controller. In addition, another processing configuration, such as a parallel processor, is also possible.

The software may include a computer program, code, instruction, or a combination of one or more thereof, and may configure the processing device to operate as desired or may command the processing device independently or collectively. The software and/or data may be embodied in any type of machine, component, physical device, computer storage medium, or device, to be interpreted by the processing device or to provide commands or data to the processing device. The software may be distributed on network-connected computer systems and stored or executed in a distributed manner. The software and data may be stored in one or more computer-readable recording medium.

The method according to an embodiment may be implemented in the form of a program command that may be performed through various computer means and recorded on a computer-readable medium. In this case, the medium may continuously store a program executable by the computer or may temporarily store the program for execution or download. In addition, the medium may be various recording means or storage means in the form of a single or a combination of several hardware, but is not limited to a medium directly connected to a certain computer system, and may exist distributed on the network. Examples of media may include a magnetic medium such as a hard disk, floppy disk, and magnetic tape, optical recording medium such as a CD-ROM and DVD, magneto-optical medium, such as a floptical disk, and those configured to store program instructions, including ROM, RAM, flash memory, and the like. In addition, examples of other media may include recording media or storage media managed by app stores that distribute applications, sites that supply or distribute various software, servers, and the like.

As described above, although various example embodiments have been described with limited examples and drawings, one skilled in the relevant technical field is capable of various modifications and transform from the above description. For example, even if the described technologies are performed in a different order from the described method, and/or the components of the described system, structure, device, circuit, and the like are coupled or combined in a different form from the described method, or replaced or substituted by other components or equivalents, appropriate a result may be achieved.

It will also be understood that any of the embodiment(s) described herein may be used in conjunction with any other embodiment(s) described herein.

No claim element is to be construed under the provisions of 35 U.S.C. § 112, sixth paragraph, unless the element is expressly recited using the phrase “means for” or “means.”

What is claimed is:

1. An electronic device comprising:
a display;
at least one processor comprising processing circuitry; and
memory, comprising one or more storage mediums, storing instructions,
wherein at least one processor individually or collectively, is configured to execute the instructions and to cause the electronic device to:
display, via the display, an image including at least one object;
receive an input with respect to the at least one object;
based at least in part on the input, generate an artificial intelligence (AI) image using an AI model wherein the at least one object is replaced with an AI generated object;
generate first information with respect to the input and second information with respect to the AI generated object; and
store, in the memory, a file including the AI image and metadata including the first information and the second information.

2. The electronic device of claim 1, wherein at least one processor individually or collectively, is configured to cause the electronic device to:
display the AI image as a replacement of the image; and
receive another input to store the AI image while displaying the AI image.

3. The electronic device of claim 1, wherein at least one processor individually or collectively, is configured to cause the electronic device to:
generate the first information including a prompt corresponding to a natural language sentence describing the at least one object.

4. The electronic device of claim 3, wherein at least one processor individually or collectively, is configured to cause the electronic device to:
obtain the second information including another prompt including a word having a meaning opposite to a word included in the prompt included in the first information.

5. The electronic device of claim 1, wherein at least one processor individually or collectively, is configured to cause the electronic device to:
as at least part of generating of the first information, generate the first information including feature information associated with the at least one object.

6. The electronic device of claim 1, wherein at least one processor individually or collectively, is configured to cause the electronic device to:
as at least part of generating of the first information, generate the first information including pixel information of the replaced at least one object.

7. The electronic device of claim 6, wherein at least one processor individually or collectively, is configured to cause the electronic device to:
generate the first information further including a prompt associated with the AI generated object.

8. The electronic device of claim 1, wherein at least one processor individually or collectively, is configured to cause the electronic device to:
as at least part of generating of the second information, generate the second information indicating a pixel difference between the image and the AI image.

9. A non-transitory computer-readable storage medium comprising instructions, wherein the instructions, when executed by at least one processor, comprising processing circuitry, individually and/or collectively, of an electronic device including a display, cause the electronic device to:
display, via the display, an image including at least one object
receive an input with respect to the at least one object;
based at least in part on the input, generate an artificial intelligence (AI) image using an AI model wherein the at least one object is replaced with an AI generated object;
generate first information with respect to the input and second information with respect to the AI generated object; and
store, in memory of the electronic device, a file including the AI image and metadata including the first information and the second information.

10. The non-transitory computer-readable storage medium of claim 9, wherein the instructions, when executed by at least one processor, comprising processing circuitry, individually and/or collectively, of the electronic device, cause the electronic device to:
display the AI image as a replacement of the image; and
receive another user input to store the AI image while displaying the AI image.

11. The non-transitory computer-readable storage medium of claim 9, wherein the instructions, when executed by at least one processor, comprising processing circuitry, individually and/or collectively, of the electronic device, cause the electronic device to:
generate the first information including a prompt corresponding to a natural language sentence describing the at least one object.

12. The non-transitory computer-readable storage medium of claim 11, wherein the instructions, when executed by at least one processor, comprising processing circuitry, individually and/or collectively, of the electronic device, cause the electronic device to:
obtain the second information including another prompt including a word having a meaning opposite to a word included in the prompt included in the first information.

13. The non-transitory computer-readable storage medium of claim 9, wherein the instructions, when executed by at least one processor, comprising processing circuitry, individually and/or collectively, of the electronic device, cause the electronic device to:
as at least part of generating of the first information, generate the first information including feature information associated with the at least one object.

14. The non-transitory computer-readable storage medium of claim 9, wherein the instructions, when executed by at least one processor, comprising processing circuitry, individually and/or collectively, of the electronic device, cause the electronic device to:
as at least part of generating of the first information, generate the first information including a pixel information of the replaced at least one object.

15. The non-transitory computer-readable storage medium of claim 14, wherein the instructions, when executed by at least one processor, comprising processing circuitry, individually and/or collectively, of the electronic device, cause the electronic device to:
generate the first information further including a prompt associated with the AI generated object.

16. The non-transitory computer-readable storage medium of claim 9, wherein the instructions, when executed by at least one processor, comprising processing circuitry, individually and/or collectively, of an electronic device, cause the electronic device to:
as at least part of generating of the second information, generate the second information indicating pixel differences between the image and the AI image.

17. A method of operating an electronic device comprising a display, comprising:
displaying, on the display, an edit screen including an original image;
based on receiving a first input to edit the original image, changing a first portion of the original image;
while displaying an edited image which is the original image of which the first portion is changed to a second portion, based on receiving a second input to store the edited image, storing a file including:
a first metadata indicating the second portion;
a second metadata including information to restore content of the first portion of the original image different from the edited image using an artificial intelligence model; and
the edited image from among the original image or the edited image.

18. The method of claim 17, wherein the changing comprises:
obtaining the edited image where the first portion is changed by executing an artificial intelligence model using a first prompt indicated by the first input.

19. The method of claim 18, wherein the storing comprises:
storing, in the first metadata, the first prompt;
storing, in the second metadata, a second prompt including a word having a meaning opposite to a word included in the first prompt.

20. The method of claim 17, wherein the storing comprises:
storing, in the second metadata, at least one prompt describing the content of the first portion to be input to the artificial intelligence model.
